(19) United States
(12) Patent Application Publication
(10) Pub. No.: US 2026/0172310 A1
(43) Pub. Date: Jun. 18, 2026

(54) ELECTRONIC DEVICE FOR GROUPING IOT DEVICES AND METHOD THEREOF

(71) Applicant: Samsung Electronics Co., Ltd., Suwon-si (KR)

(72) Inventors: Kibong CHOI, Suwon-si (KR); Jongman PARK, Suwon-si (KR); Seokhyun KIM, Suwon-si (KR)

(21) Appl. No.: 19/389,823

(22) Filed: Nov. 14, 2025

Related U.S. Application Data
(63) Continuation of application No. PCT/KR2025/017933, filed on Nov. 4, 2025.

(30) Foreign Application Priority Data
Dec. 18, 2024 (KR) 10-2024-0189996
Jan. 13, 2025 (KR) 10-2025-0004933

(51) Int. Cl. H04L 41/0893; H04W 4/70; H04W 4/80; H04W 64/00; H04W 76/14

(52) U.S. Cl. CPC H04L 41/0893; H04W 4/70; H04W 4/80; H04W 64/003; H04W 76/14

(57) ABSTRACT

An electronic device is provided. The electronic device includes communication circuitry, memory, including one or more storage media, storing instructions, and at least one processor communicatively coupled to the communication circuitry and the memory, wherein the instructions, when executed by the processor individually or collectively, cause the electronic device to receive a first user input requesting sensor grouping of an Internet of things (IoT) device, display, based on the first user input, a guide message requesting movement to the IoT device, discover, after displaying the guide message, the IoT device by using a short-range communication method, discover, after discovering the IoT device, one or more external sensor devices by using the short-range communication method, receive sensor device information and signal strength information from the one or more external sensor devices, group, based on the sensor device information and the signal strength information, at least one external sensor device among the one or more external sensor devices with the IoT device, and determine an operating situation of the IoT device, based on sensor data received from the at least one grouped external sensor device.

### CROSS-REFERENCE TO RELATED APPLICATION(S)

This application is a continuation application, claiming priority under 35 U.S.C. § 365(c), of an International application No. PCT/KR2025/017933, filed on Nov. 4, 2025, which is based on and claims the benefit of a Korean patent application number 10-2024-0189996, filed on Dec. 18, 2024, in the Korean Intellectual Property Office, and of a Korean patent application number 10-2025-0004933, filed on Jan. 13, 2025, in the Korean Intellectual Property Office, the disclosure of each of which is incorporated by reference herein in its entirety.

### BACKGROUND

### 1. Field

The disclosure relates to an electronic device and a method for grouping Internet of Things devices.

### 2. Description of Related Art

Various services and additional features provided through user terminals, such as electronic devices like smartphone, are steadily increasing. To enhance the utility value of these electronic devices and meet the diverse needs of users, communication service providers and electronic device manufacturers are competitively developing electronic devices that provide various functions. As a result, the various functions provided through electronic devices are also becoming increasingly sophisticated.

With the advancement of wireless communication technology, devices utilizing artificial intelligence (AI) are being widely adopted. For example, home appliances connected to a network through Internet of things (IoT) technology can utilize artificial intelligence. IoT technology can collect and analyze data generated by devices to provide intelligent Internet technology services that create new value in human life. Through the integration and combination of existing Internet technology and various industries, IoT technology can be applied to fields, such as smart homes, smart buildings, smart cities, smart cars, and smart appliances.

Homes are equipped with various home appliances designed for user convenience. Various services are being proposed to make the operation and control of home appliances more convenient by utilizing IoT technology. Home network technology can provide various services to users within the home through home networks. For example, users can control various controlled devices (e.g., home appliances equipped with IoT technology) that make up a home network using personal electronic devices (e.g., smartphones). Users may want to receive more diverse services to control the controlled devices. Accordingly, there is a demand for the development of various technologies that manage controlled devices according to on the intentions of users.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for grouping Internet of Things (IoT) devices.

Another aspect of the disclosure is to provide an electronic device and a method for detecting an error situation through external sensors located around home appliances.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, memory, including one or more storage media, storing instructions, and at least one processor communicatively coupled to the communication circuitry and the memory, wherein the instructions, when executed by the at least one processor individually or collectively, cause the electronic device to receive a first user input requesting sensor grouping of an Internet of Things (IoT) device, based on the first user input, display a guide message requesting movement to the IoT device, after displaying the guide message, discover the IoT device by using a short-range communication method through the communication circuitry,, after discovering the IoT device, discover one or more external sensor devices by using the short-range communication method through the communication circuitry, receive sensor device information and signal strength information from the one or more external sensor devices through the communication circuitry, based on the sensor device information and the signal strength information, group at least one external sensor device among the one or more external sensor devices with the IoT device, and, based on sensor data received from the at least one grouped external sensor device through the communication circuitry, determine an operating situation of the IoT device.

In accordance with another aspect of the disclosure, an IoT device is provided. The IoT device includes communication circuitry, memory, including one or more storage media, storing instructions, and at least one processor communicatively coupled to the communication circuitry and the memory, wherein the instructions, when executed by the at least one processor individually or collectively, cause the IoT device to receive a command requesting a surrounding sensor search from an electronic device through the communication circuitry, based on receiving the command, discover one or more external sensor devices by using a short-range communication method through the communication circuitry, receive sensor device information and signal strength information from the one or more external sensor devices through the communication circuitry, based on the sensor device information and the signal strength information, group at least one external sensor device among the one or more external sensor devices with the IoT device, receive sensor data from the at least one external sensor device through the communication circuitry, and transmit the sensor data to the electronic device through the communication circuitry.

In accordance with another aspect of the disclosure, a method performed by an electronic device is provided. The method includes receiving a first user input requesting sensor grouping of an Internet of things (IoT) device, based on the first user input, displaying a guide message requesting movement to the IoT device, after displaying the guide message, discovering the IoT device by using a short-range communication method, after discovering the IoT device, discovering one or more external sensor devices by using the short-range communication method, receiving sensor device information and signal strength information from the one or more external sensor devices through a communication circuitry, based on the sensor device information and the signal strength information, grouping at least one external sensor device among the one or more external sensor devices with the IoT device, and based on sensor data received from the at least one grouped external sensor device, determining an operating situation of the IoT device.

In accordance with another aspect of the disclosure, a method performed by an IoT device is provided. The method includes receiving, from an electronic device, a command requesting a surrounding sensor search, based on receiving the command, discovering, one or more external sensor devices by using a short-range communication method, receiving sensor device information and signal strength information from the one or more external sensor devices through a communication circuitry, based on the sensor device information and the signal strength information, grouping at least one external sensor device among the one or more external sensor devices with the IoT device, and transmitting sensor data, received from the at least one external sensor device, to the electronic device.

In accordance with another aspect of the disclosure, in one or more non-transitory computer-readable storage media storing one or more computer programs including computer-executable instructions that, when executed by at least one processor of an electronic device individually or collectively, cause the electronic device to perform operations are provided. The operations include receiving a first user input requesting sensor grouping of an Internet of things (IoT) device, based on the first user input, displaying a guide message requesting movement to the IoT device, after displaying the guide message, discovering the IoT device by using a short-range communication method, after discovering the IoT device, discovering one or more external sensor devices by using the short-range communication method, receiving sensor device information and signal strength information from the one or more external sensor devices through a communication circuitry, based on the sensor device information and the signal strength information, grouping at least one external sensor device among the one or more external sensor devices with the IoT device, and based on sensor data received from the at least one grouped external sensor device, determining an operating situation of the IoT device.

In accordance with another aspect of the disclosure, in one or more non-transitory computer-readable storage media storing one or more computer programs including instructions that, when executed by at least one processor of an IoT device individually or collectively, cause the IoT device to perform operations are provided. The operations include receiving, from an electronic device, a command requesting a surrounding sensor search, based on receiving the command, discovering one or more external sensor devices by using a short-range communication method through communication circuitry, receiving sensor device information and signal strength information from the one or more external sensor devices through the communication circuitry, based on the sensor device information and the signal strength information, grouping at least one external sensor device among the one or more external sensor devices with the IoT device, receiving sensor data received from the at least one grouped external sensor device through the communication circuitry, and transmitting the sensor data to the electronic device through the communication circuitry.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an Internet of Things (IoT) system according to an embodiment of the disclosure;

FIG. 2 is a block diagram of electronic devices in a network environment according to an embodiment of the disclosure;

FIG. 3 illustrates a system structure including controlled devices according to an embodiment of the disclosure;

FIG. 4A is a block diagram illustrating a configuration of an IoT device according to an embodiment of the disclosure;

FIG. 4B is a block diagram illustrating a configuration of a server for performing IoT control according to an embodiment of the disclosure;

FIGS. 5A and 5B illustrate execution screens of an IoT client application according to various embodiments of the disclosure;

FIGS. 6A and 6B illustrate system configurations for error management of an IoT device according to various embodiments of the disclosure;

FIG. 7 illustrates a table showing sensors required according to a type of home appliance according to an embodiment of the disclosure;

FIG. 8 is a flowchart illustrating a procedure for performing a surrounding sensor search by an IoT device according to an embodiment of the disclosure;

FIG. 9 is a flowchart illustrating a procedure for performing a surrounding sensor search by an electronic device according to an embodiment of the disclosure;

FIG. 10 is a sequence diagram illustrating a surrounding sensor search and sensor grouping according to an embodiment of the disclosure;

FIG. 11 is a sequence diagram illustrating sensor grouping based on a sensor list according to an embodiment of the disclosure;

FIG. 12 is a sequence diagram illustrating a surrounding sensor search and sensor grouping according to an embodiment of the disclosure;

FIG. 13 is a sequence diagram illustrating a surrounding sensor search using a mobile device according to an embodiment of the disclosure;

FIGS. 14A and 14B illustrate a selection of sensors according to various embodiments of the disclosure;

FIG. 15 is a sequence diagram illustrating a procedure for selecting a sensor to be grouped according to an embodiment of the disclosure;

FIG. 16 illustrates a procedure for extracting a threshold range, based on sensor data according to an embodiment of the disclosure;

FIG. 17 is a flowchart illustrating a procedure for detecting an error situation according to an embodiment of the disclosure;

FIG. 18 is a flowchart illustrating a procedure for analyzing an error situation according to an embodiment of the disclosure;

FIG. 19 is a flowchart illustrating error situation detection based on sensor data collected from a grouped sensor according to an embodiment of the disclosure; and

FIGS. 20A, 20B, and 20C illustrate user interfaces showing a grouped sensor according to various embodiments of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include a plural referents unless the context clearly dictates otherwise. Thus, for example, reference to “a component surface” includes reference to one or more of such surfaces.

As used herein, such an expression as “comprises” or “include” should not be interpreted to necessarily include all elements or all steps described in the specification, and should be interpreted to be allowed to exclude some of them or further include additional elements or steps.

As used herein, the terms including an ordinal number, such as expressions “a first” and “a second”, may be used to described various elements, but the corresponding elements should not be limited by such terms. The above terms are used merely for the purpose of distinguishing one element from other elements. For example, a first element may be termed a second element, and similarly, a second element may be termed a first element without departing from the scope of protection of the disclosure.

It should be understood that when an element is referred to as being “connected” or “coupled” to another element, it may be connected or coupled directly to the other element, or any other element may be interposer between them. Contrarily, in the case where an element is referred to as being “directly connected” or “directly coupled” to any other element, it should be understood that no other element exists therebetween.

Hereinafter, embodiments according to the disclosure will be described with reference to the accompanying drawings, and the same or similar elements are given the same and similar reference numerals, regardless of drawing signs, so duplicate descriptions thereof will be omitted. In describing embodiments of the disclosure, descriptions related to technical contents well-known in the art and not associated directly with the disclosure will be omitted. It should be noted that the accompanying drawings are presented merely to help easy understanding of the disclosure, and are not intended to limit the disclosure. The disclosure should be construed to cover all changes, equivalents, and alternatives, in addition to the drawings.

In the embodiments of the disclosure, an electronic device will be described by way of example, but the electronic device may also be referred to as a terminal, a mobile station, a mobile equipment (ME), a user equipment (UE), a user terminal (UT), a subscriber station (SS), a wireless device, a handheld device, or an access terminal (AT). In the embodiments of the disclosure, the electronic device may be a device having a communication function, such as a mobile phone, a personal digital assistant (PDA), a smartphone, a wireless modem, or a notebook.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

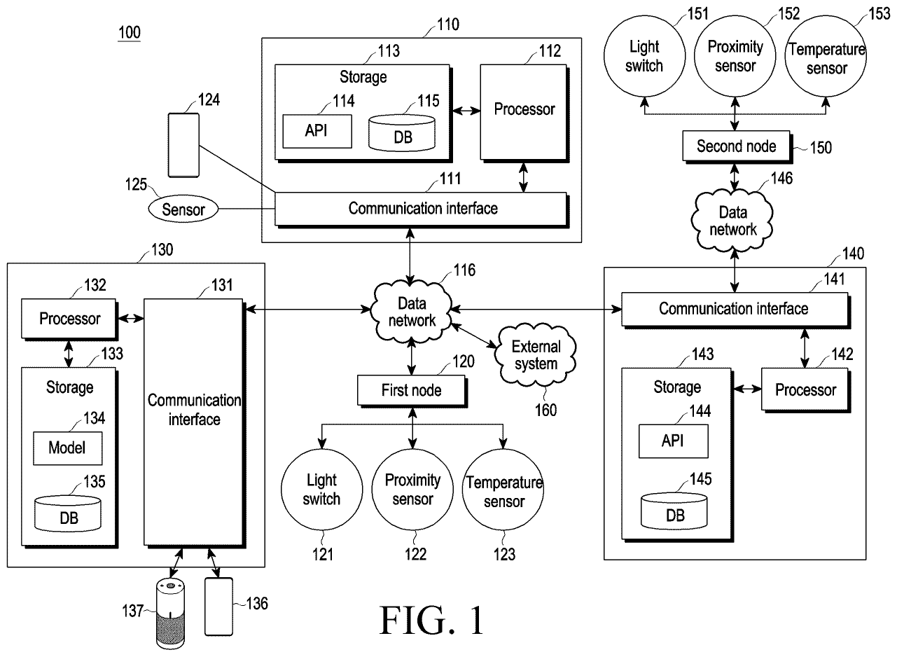

FIG. 1 illustrates an Internet of things (IoT) system according to an embodiment of the disclosure. At least some of components in FIG. 1 may be omitted, and the system may be implemented to include additional components not shown.

Referring to FIG. 1, an IoT system 100 according to an embodiment of the disclosure includes multiple electronic devices connectable to a data network 116 or 146. For example, the IoT system 100 may include at least one of a first IoT server 110, a first node 120, a voice assistance server 130, a second IoT server 140, a second node 150, or devices 121, 122, 123, 124, 125, 136, 137, 151, 152, and 153.

According to an embodiment of the disclosure, the first IoT server 110 may include at least one of a communication interface 111, a processor 112, or a storage 113. The second IoT server 140 may include at least one of a communication interface 141, a processor 142, or a storage 143. As used herein, an “IoT server” may remotely control and/or monitor one or more devices (e.g., the devices 121, 122, 123, 124, 125, 151, 152, and 153), for example, based on a data network (e.g., a data network 116 or a data network 146), through a relay device (e.g., the first node 120 or the second node 150) or directly without a relay device. As used herein, a “device” may be a sensor, an appliance, an office electronic device, or a device for performing a process, which is disposed (or located) in a local environment, such as a home, an office, a factory, a building, an external location, or other types of sites, but the type of device is not limited. A device that receives a control command and performs an operation in response to the control command may be referred to as a “target device.” The IoT server may also be referred to as a central server in that the IoT server selects a target device from multiple devices and provides a control command.

According to an embodiment of the disclosure, the first IoT server 110 may communicate with the devices 121, 122, and 123 via the data network 116. The data network 116 may refer to a network for long-range communication, such as the Internet or a computer network (e.g., LAN or WAN), or may include a cellular network.

In accordance with an embodiment of the disclosure, the first IoT server 110 may be connected to the data network 116 via the communication interface 111. The communication interface 111 may include a communication device (or a communication module) for supporting communication on the data network 116, and may be integrated into a single component (e.g., a single chip) or implemented as multiple separate components (e.g., multiple chips). The first IoT server 110 may communicate with the devices 121, 122, and 123 via the first node 120. The first node 120 may receive data from the first IoT server 110 over the data network 116 and transmit the received data to at least some of the devices 121, 122, and 123. Alternatively, the first node 120 may receive data from at least some of the devices 121, 122, and 123 and transmit the received data to the first IoT server 110 over the data network 116. The first node 120 may function as a bridge between the data network 116 and the devices 121, 122, and 123. While FIG. 1 illustrates a single first node 120, this is merely illustrative and there is no limit to the number of first nodes 120.

As used herein, a “node” may be an edge computing system, or may be a hub device. In accordance with an embodiment of the disclosure, the first node 120 may support wired and/or wireless communication of the data network 116 and may also support wired and/or wireless communication with the devices 121, 122, and 123. For example, the first node 120 may be connected to the devices 121, 122, and 123 via a short-range communication network, such as at least one of Bluetooth, Wi-Fi, Wi-Fi direct, Z-wave, Zigbee, INSETEON, X10, or infrared data association (IrDA), but the type of communication is not limited. The first node 120 may be disposed (or located) within an environment, such as a home, an office, a factory, a building, an external location, or other types of sites. Accordingly, the devices 121, 122, and 123 may be monitored and/or controlled by services provided by the first IoT server 110, and the devices 121, 122, and 123 may not be required to have full network communication (e.g., Internet communication) capability for direct connection to the first IoT server 110. The devices 121, 122, and 123 are illustrated as being implemented as electronic devices in a home environment, for example, a light switch, a proximity sensor, and a temperature sensor, and the devices are not limited thereto.

In accordance with an embodiment of the disclosure, the first IoT server 110 may also support direct communication with the devices 124 and 125. As used herein, “direct communication” may refer to communication that does not go through a relay device, such as the first node 120, and may be, for example, communication over a cellular communication network and/or a data network.

In accordance with an embodiment of the disclosure, the first IoT server 110 may transmit control commands to at least some of the devices 121, 122, 123, 124, and 125. As used herein, “control command” may refer to data that causes a controllable device to perform a particular operation, wherein the particular operation is an operation performed by the device, and may include outputting information, sensing information, reporting information, managing information (e.g., deleting, or creating), but the type thereof is not limited. For example, the processor 112 may obtain information (or, a request) for generating a control command from the outside (e.g., at least some of a voice assistant server 130, the second IoT server 140, an external system 160, or the devices 121, 122, 123, 124, and 125) and generate a control command based on the obtained information. Alternatively, the processor 112 may generate a control command, based on monitoring results of at least some of the devices 121, 122, 123, 124, and 125 satisfying designated conditions. The processor 112 may control the communication interface 111 to transmit the control command to a target device.

In accordance with an embodiment of the disclosure, the processor 112, a processor 132, or the processor 142, may be implemented as a combination of one or more among a general-purpose processor, such as a central processing unit (CPU), a digital signal processor (DSP), an application processor (AP), or a communication processor (CP), a graphics-only processor, such as a graphics processing unit (GPU) or a vision processing unit (VPU), or an artificial intelligence-only processor, such as a neural processing unit (NPU). Those skilled in the art will understand that the processor 112 may be, for example, any computational means capable of executing instructions stored in memory 113 and outputting the execution results, without limitation.

In accordance with an embodiment of the disclosure, the processor 112 may configure a web-based interface based on an application programmable interface (API) 114, or expose resources managed by the first IoT server 110 to the outside. The web-based interface may support communication between, for example, the first IoT server 110 and an external web service. The processor 112 may allow, for example, an external system 160 to control and/or access the devices 121, 122, and 123. The external system 160 may be, for example, an independent system that is not associated with, or a part of, the system 100. The external system 160 may be, for example, an external server or a website. However, security is required for access from the external system 160 to the devices 121, 122, and 123 or resources of the first IoT server 110. In accordance with an embodiment of the disclosure, the processor 112 may allow an automation application to expose an API endpoint (e.g., a universal resource locator (URL)) based on the API 114 to the outside. As described above, the first IoT server 110 may transmit a control command to a target device among the devices 121, 122, and 123. The description of the communication interface 141, the processor 142, and an API 144 and a database 145 of the storage 143 in the second IoT server 140 may be substantially the same as the description of the communication interface 111, the processor 112, and the API 114 and a database 115 of the storage 113 in the first IoT server 110. Further, the description of the second node 150 may be substantially the same as the description of the first node 120. The second IoT server 140 may transmit a control command to a target device among the devices 151, 152, and 153. The first IoT server 110 and the second IoT server 140 may be operated by the same service provider in an embodiment of the disclosure, but may each be operated by different service providers in another embodiment.

In accordance with to an embodiment of the disclosure, the voice assistant server 130 may transmit and receive data to and from the first IoT server 110 via the data network 116. The voice assistant server 130 according to an embodiment may include at least one of a communication interface 131, a processor 132, or a storage 133. The communication interface 131 may communicate with a smartphone 136 or an AI speaker 137 via a data network (not shown) and/or a cellular network (not shown). The smartphone 136 or the AI speaker 137 may include a microphone, and may acquire a user voice, convert the user voice to a voice signal, and transmit the voice signal to the voice assistant server 130. The processor 132 may receive the voice signal from the smartphone 136 or the AI speaker 137 via the communication interface 131. The processor 132 may process the received speech signal, based on a stored model 134. The processor 132 may generate (or identify) a control command by using the processing result, based on information stored in a database 135. In accordance with to an embodiment of the disclosure, the storage 113, 133, and 143 may include flash memory type, hard disk type, multimedia card micro type, or card type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, or a non-transitory storage medium of at least one type of magnetic disk or optical disk, and the types thereof are not limited.

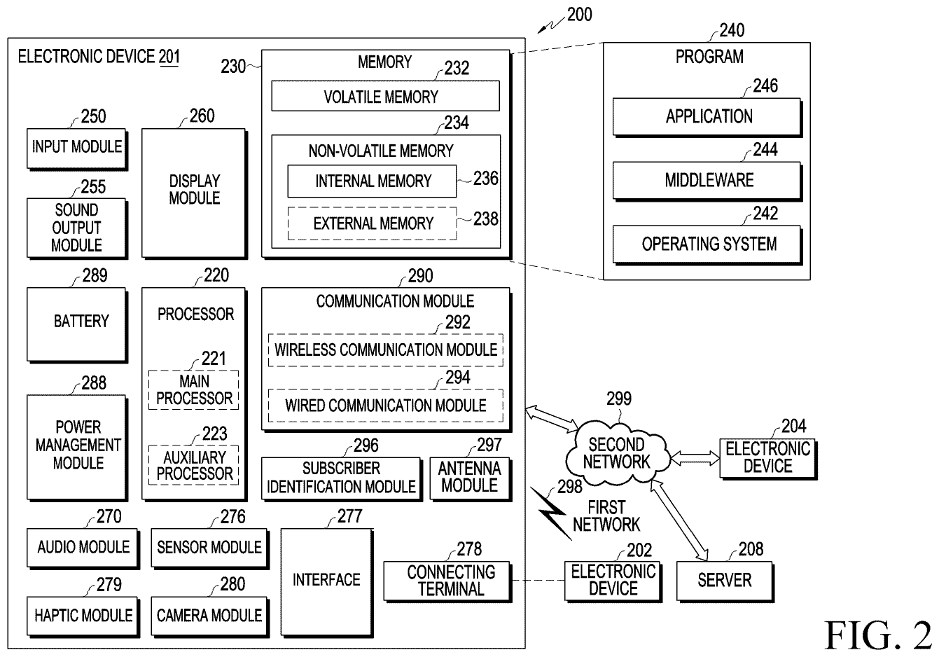

In various embodiments of the disclosure, at least one device (e.g., the device 124) communicating with the first IoT server 110 may be a smartphone (e.g., the electronic device 201 in FIG. 2) in a networked environment.

FIG. 2 is a block diagram illustrating an electronic device in a network environment according to an embodiment of the disclosure.

Referring to FIG. 2, the electronic device 201 in the network environment 200 may communicate with an electronic device 202 via a first network 298 (e.g., a short-range wireless communication network), or at least one of an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In some embodiments, at least one of the components (e.g., the connecting terminal 278) may be omitted from the electronic device 201, or one or more other components may be added in the electronic device 201. In some embodiments, some of the components (e.g., the sensor module 276, the camera module 280, or the antenna module 297) may be implemented as a single component (e.g., the display module 260).

The processor 220 may execute, for example, software (e.g., a program 240) to control at least one other component (e.g., a hardware or software component) of the electronic device 201 coupled with the processor 220, and may perform various data processing or computation. According to one embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, when the electronic device 201 includes the main processor 221 and the auxiliary processor 223, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223. According to an embodiment, the auxiliary processor 223 (e.g., the neural processing unit) may include a hardware structure specified for artificial intelligence model processing. An artificial intelligence model may be generated by machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input module 250 may receive a command or data to be used by another component (e.g., the processor 220) of the electronic device 201, from the outside (e.g., a user) of the electronic device 201. The input module 250 may include, for example, a microphone, a mouse, a keyboard, a key (e.g., a button), or a digital pen (e.g., a stylus pen).

The sound output module 255 may output sound signals to the outside of the electronic device 201. The sound output module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display module 260 may include a touch sensor adapted to detect a touch, or a pressure sensor adapted to measure the intensity of force incurred by the touch.

The audio module 270 may convert a sound into an electrical signal and vice versa. According to an embodiment, the audio module 270 may obtain the sound via the input module 250, or output the sound via the sound output module 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to one embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, or infrared data association (IrDA)) or the second network 299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The wireless communication module 292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., the mmWave band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 297 may transmit or receive a signal or power to or from the outside (e.g., the external electronic device) of the electronic device 201. According to an embodiment, the antenna module 297 may include an antenna including a radiating element composed of a conductive material or a conductive pattern formed in or on a substrate (e.g., a printed circuit board (PCB)). According to an embodiment, the antenna module 297 may include a plurality of antennas (e.g., array antennas). In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297.

According to various embodiments, the antenna module 297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 or 204 may be a device of a same type as, or a different type, from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In another embodiment, the external electronic device 204 may include an internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or healthcare) based on 5G communication technology or IoT-related technology.

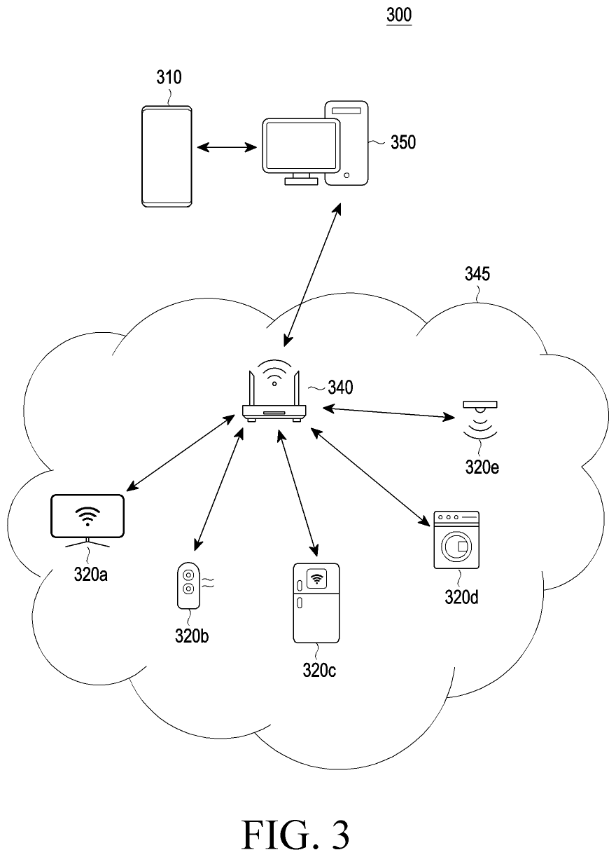

FIG. 3 illustrates a system structure including controlled devices according to an embodiment of the disclosure.

Referring to FIG. 3, an IoT system 300 (e.g., an IoT network) may include a server 350 configured to operate as an IoT cloud and/or account server, an electronic device 310 (e.g., the electronic device 201), and one or more controlled devices (e.g., IoT devices 320a, 320b, 320c, 320d, and 320e) within a local network 345.

In an embodiment of the disclosure, the electronic device 310 may be configured to communicate with the server 350 via long-range wireless communication (e.g., the second network 299). In an embodiment of the disclosure, the electronic device 310 may be configured to operate as a hub for the IoT devices 320a, 320b, 320c, 320d, and 320e. In an embodiment of the disclosure, at least one of the IoT devices 320a, 320b, 320c, 320d, and 320e may be configured to communicate with the electronic device 310 by using short-range wireless communication (e.g., Wi-Fi, Bluetooth legacy, Bluetooth low energy (BLE), ultra-wideband (UWB), Zigbee, and/or near-field communication (NFC)). In an embodiment of the disclosure, at least one of the IoT devices 320a, 320b, 320c, 320d, and 320e may support IoT technology and may be configured to access the Internet via an access point (AP) 340 and communicate with the server 350 via the Internet.

In an embodiment of the disclosure, any one (e.g., the IoT device 320a) (e.g., a television, a home automation panel, a personal computer (PC), a smartphone, or a tablet) of the IoT devices 320a, 320b, 320c, 320d, and 320e may be configured to have a hub function configured to manage the connectivity and state of the IoT devices 320a, 320b, 320c, 320d, and 320e. The IoT device 320a may communicate with the server 350 via an AP 340, and, similarly to the IoT devices 320a, 320b, 320c, 320d, and 320e, may be onboarded and then registered with the server 350.

In an embodiment of the disclosure, the electronic device 310 may communicate with (e.g., control or manage) the IoT devices 320a, 320b, 320c, 320d, and 320e via the server 350 through long-range wireless communication (e.g., the second network 299) or short-range wireless communication (e.g., the first network 298).

In an embodiment of the disclosure, the IoT devices 320a, 320b, 320c, 320d, and 320e may include at least one of, for example, a television, an air conditioner, an air purifier, a refrigerator, a washing machine, a light bulb, a security camera, a sensor, or a window treatment. In an embodiment of the disclosure, the IoT devices 320a, 320b, 320c, 320d, and 320e may be configured to be controlled (e.g., to execute state reporting and/or designated actions) by remote commands (e.g., control commands from the electronic device 310 or the server 350). In an embodiment of the disclosure, the IoT devices 320a, 320b, 320c, 320d, and 320e may communicate with the electronic device 310 via the AP 340 within the local network 345, communicate with the electronic device 310 via the server 350, and/or communicate with the electronic device 310 directly (e.g., without passing through the server 350, the AP 340, or another device) via a device-to-device (D2D) connection.

In an embodiment of the disclosure, the IoT devices 320a, 320b, 320c, 320d, and 320e may be configured to communicate with the electronic device 310 via long-range wireless communication (e.g., the second network 299) or via short-range wireless communication (e.g., the first network 298). In an embodiment of the disclosure, the IoT devices 320a, 320b, 320c, 320d, and 320e may be configured to communicate with the server 350 via long-range wireless communication (e.g., the second network 299) or via short-range wireless communication (e.g., the first network 298).

In an embodiment of the disclosure, at least one of the IoT devices 320b, 320c, 320d, and 320e may be a hub-connected device that establishes a device-to-device (D2D) connection (e.g., a Bluetooth connection, a BLE connection, a UWB connection, a ZigBee connection, a Z-Wave connection, or a Wi-Fi connection) with an IoT device (e.g., the IoT device 320a) operating as a hub and receives a control command from or reports a state to the server 350 via the IoT device 320a. In an embodiment of the disclosure, at least one of the IoT devices 320b, 320c, 320d, and 320e may be a cloud-connected device configured to receive a control command from or report a state to the server 350 via the AP 340. In an embodiment of the disclosure, at least one of the IoT devices 320b, 320c, 320d, and 320e may be a cloud-to-cloud device that is registered with a third-party cloud and controlled via an inter-cloud application programmable interface (API).

In an embodiment of the disclosure, the electronic device 310 may be, for example, a personal electronic device, such as a smartphone or a tablet, or an electronic device having a display and a user interface, such as a television or a control console. In an embodiment of the disclosure, the electronic device 310 may be configured to perform at least some of the functions described below directly or through connection (e.g., pairing) with at least one external electronic device (e.g., a wearable device, such as a smart watch).

In an embodiment of the disclosure, the electronic device 310 may discover at least one of the IoT devices 320a, 320b, 320c, 320d, and 320e, and may execute a procedure (e.g., a registration procedure) to register the discovered IoT device with the server 350. The IoT devices 320a, 320b, 320c, 320d, and 320e may be registered with the server 350 to be associated with a user account, and may allow logging in (e.g., sign-in) using the user account. Based on the user account, the electronic device 310 may monitor and/or control the IoT devices 320a, 320b, 320c, 320d, and 320e. In an embodiment of the disclosure, the electronic device 310 may check the state of the IoT devices 320a, 320b, 320c, 320d, and 320e that a user is to use for IoT services, and/or may control (e.g., transmit control commands to perform certain actions to) the IoT devices 320a, 320b, 320c, 320d. 320e.

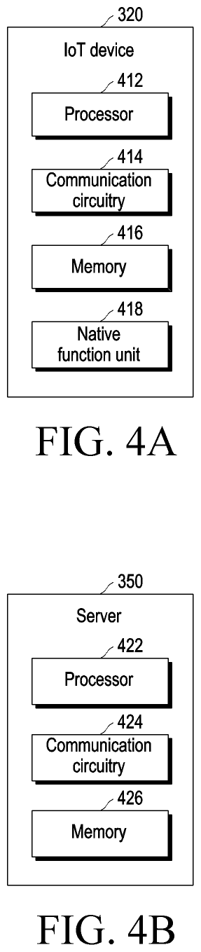

FIG. 4A is a block diagram illustrating a configuration of an IoT device 320 according to an embodiment of the disclosure.

Referring to FIG. 4A, the IoT device 320 may be an IoT device (e.g., any one of the IoT devices 320a, 320b, 320c, 320d, and 320e) that performs an IoT service (e.g., an event-based IoT service) on an IoT network (e.g., the network 300). For example, the IoT network may be a smart home network, and the IoT service may be an automation service.

In an embodiment of the disclosure, the IoT device 320 may include at least one processor 412 including processing circuitry, communication circuitry 414, memory 416 for storing instructions, and/or a native function unit 418 for performing a native function of a home appliance. In an embodiment of the disclosure, the IoT device 320 may be TV or a device including a display. In an embodiment of the disclosure, when the IoT device 320 is a smart TV, the native function unit 418 may include TV receiving circuitry and a display. In an embodiment of the disclosure, when the IoT device 320 is a smart washing machine, the native function unit 418 may include a motor and control circuitry. In an embodiment of the disclosure, when the IoT device 320 is a smart refrigerator, the native function unit 418 may include cooling circuitry and control circuitry.

In an embodiment of the disclosure, the communication circuitry 414 may transmit and receive wireless signals to and from external electronic devices (e.g., the electronic device 310, the AP 340, the server 350, and/or other IoT devices). The IoT device 320 may support a designated short-range wireless communication technology (e.g., at least one of Zigbee, Z-Wave, ultra-wide-band (UWB), or Wi-Fi) via the communication circuitry 414. The communication circuitry 414 may include one or more communication circuits based on a designated short-range wireless communication technology (e.g., Zigbee, Z-Wave, UWB, and/or Wi-Fi).

In an embodiment of the disclosure, the processor 412 may be implemented as one or more single-core processors or one or more multi-core processors. In an embodiment of the disclosure, the memory 416 may store instructions and data for operation of the IoT device 320. In an embodiment of the disclosure, the memory 416 may store relevant information and/or data according to embodiments of the disclosure.

In an embodiment of the disclosure, the processor 412 may control or manage the state (e.g., accessibility configuration state) and actions (e.g., accessibility features) of the IoT device 320 related to IoT services. In an embodiment of the disclosure, the processor 412 may receive a control command related to control of the IoT device 320 from the electronic device 310 and/or the server 350, and may operate in response to the control command. In an embodiment of the disclosure, the control command may be received via the AP 340.

FIG. 4B is a block diagram illustrating a configuration of a server for performing IoT control according to an embodiment of the disclosure.

Referring to FIG. 4B, the server 350 may control and manage components (e.g., the IoT devices 320a, 320b, 320c, 320d, and 320e, and the electronic devices 310) that perform an IoT service (e.g., an event-based IoT service) on an IoT network (e.g., the network 300). In an embodiment of the disclosure, the server 350 may be configured to communicate with the IoT devices 320a, 320b, 320c, 320d, and 320e, and the electronic device 310 over an external network (e.g., the Internet). In an embodiment of the disclosure, the server 350 may include at least one processor 422 including processing circuitry, communication circuitry 424, and/or memory 426 for storing instructions.

In an embodiment of the disclosure, the communication circuitry 424 may transmit and receive control messages and data to and from external electronic devices (e.g., the electronic device 310 and/or the IoT devices 320a, 320b, 320c, 320d, and 320e). In an embodiment of the disclosure, the processor 422 may be implemented as one more single-core processors or as one or more multi-core processors. In an embodiment of the disclosure, the memory 426 may store instructions and data for operation of the server 350. In an embodiment of the disclosure, the memory 426 may store relevant information and/or data according to embodiments of the disclosure.

In an embodiment of the disclosure, the processor 422 may control or manage the state (e.g., sensor data and/or error situation) and actions (e.g., fault resolution actions for error situations) of devices (e.g., the electronic device 310 and the IoT device 320) related to an IoT service. In an embodiment of the disclosure, the processor 422 may receive information related to control of the electronic device 310 and/or the IoT device 320 from the electronic device 310 and/or the IoT device 320, and may manage and/or control the electronic device 310 and/or the IoT device 320, based on the received information. The control command may be transmitted to the IoT device 320 via the AP 340.

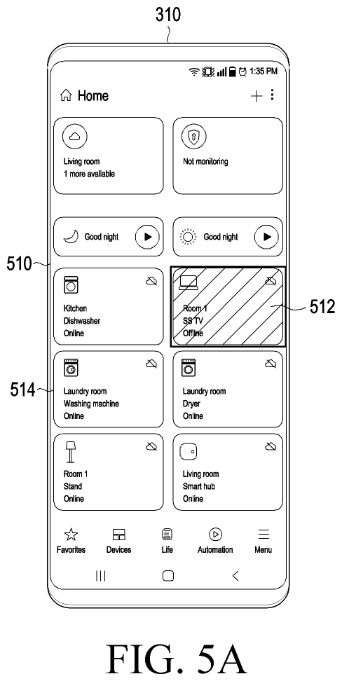

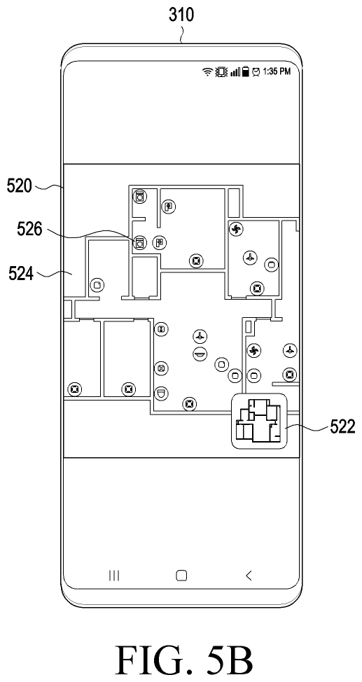

FIGS. 5A and 5B illustrate execution screens of an IoT client application according to various embodiments of the disclosure.

Referring to FIG. 5A, an electronic device 310 may execute an IoT client application for an IoT service and display a dashboard screen 510 via a display module (e.g., the display module 260), based on the execution of the client application. The dashboard screen 510 may include objects (e.g., objects 512 and 514) that represent the states of one or more onboarded IoT devices (e.g., the IoT devices 320a, 320b, 320c, 320d, and 320e). In an embodiment of the disclosure, the objects may be arranged in a tile grid form.

In an embodiment of the disclosure, each object may include at least one of an image, a location (e.g., room information), a name, or a connection status (e.g., online or offline) corresponding to a corresponding IoT device. In an embodiment of the disclosure, the object 512 corresponding to TV may include information, such as {TV image, Location=Room1, Device Type/Name=SSTV, and Connection Status=Offline}. In an embodiment of the disclosure, the object 514 corresponding to a washing machine may include information, such as {Washing Machine Image, Location=Laundry Room, Device Type/Name=Washing Machine, and Connection Status=Online}.

In an embodiment of the disclosure, when any one (e.g., room 1 TV) of the IoT devices 320a, 320b, 320c, 320d, and 320e is connected to the server 350 and is operating normally, the object 512 corresponding to the room 1 TV may indicate an online state (e.g., in a normal state). In an embodiment of the disclosure, when any one (e.g., a washing machine) of the IoT devices 320a, 320b, 320c, 320d, and 320e is not connected to the server 350 or is not operating normally, the object 514 corresponding to the washing machine may indicate an offline state (e.g., an error situation). In an embodiment of the disclosure, the IoT devices 320a, 320b, 320c, 320d, and 320e may log in (e.g., sign-in) to the server 350 using a user account in an online state.

Referring to FIG. 5B, an electronic device 310 may execute a client application for an IoT control service and display a map view screen 520 via a display module (e.g., the display module 260), based on the execution of the client application. The map view screen 520 may include a simplified map image 522 corresponding to a local network (e.g., the local network 345 in FIG. 3), and a detailed map image 524 including an expanded image of at least a partial region of the simplified map image 522.

In an embodiment of the disclosure, the simplified map image 522 may represent a building structure (e.g., floor plan) corresponding to a local network (e.g., the local network 345 in FIG. 3) for IoT services and including multiple rooms. In an embodiment of the disclosure, the detailed map image 524 may represent a partial floor plan corresponding to a partial region of the simplified map image 522 and may include device symbols (e.g., a device symbol 526) displayed on the partial floor plan. In an embodiment of the disclosure, each device symbol may be placed at a virtual location on the detailed map image 524 that corresponds to an actual location (e.g., a kitchen) where a corresponding IoT device is installed. In an embodiment of the disclosure, the device symbol 526 may be mapped to a washing machine located in a kitchen.

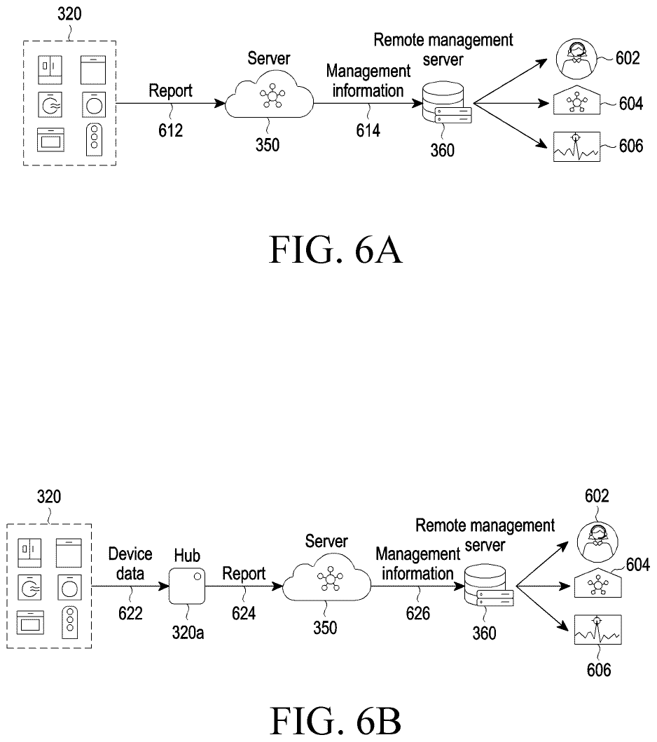

FIGS. 6A and 6B illustrate system configurations for error management of an IoT device according to various embodiments of the disclosure.

Referring to FIG. 6A, an IoT device 320 or an electronic device 310 may collect device data indicating the state (e.g., operating state) of the IoT device 320 and transmit a reporting message 612 including the device data to a server 350. In an embodiment of the disclosure, the reporting message 612 may include sensor data, control data, configuration data, and/or error situation information, related to the IoT device 320. In an embodiment of the disclosure, the IoT device 320 may collect the sensor data from at least one built-in sensor (e.g., at least one of a temperature sensor, a vibration sensor, a microphone, a battery monitor, an air quality sensor, or a water leak sensor). In an embodiment of the disclosure, the server 350 may forward management information 614 based on the reporting message 612 to a remote management server 360.

Referring to FIG. 6B, an IoT device 320 may collect device data 622 indicating the state (e.g., operating state) of the IoT device 320, and may transmit the device data 622 to a hub (e.g., the IoT device 320a in FIG. 3) within a local network (e.g., the local network 345 in FIG. 3). In an embodiment of the disclosure, a reporting message 624 may include sensor data, control data, configuration data, and/or error situation information, related to the IoT device 320. In an embodiment of the disclosure, the IoT device 320 may collect the sensor data from at least one built-in sensor (e.g., at least one of a temperature sensor, a vibration sensor, a microphone, a battery sensor, an air quality sensor, or a water leak sensor).

In an embodiment of the disclosure, the IoT device 320a operating as the hub may transmit, to a server 350, a reporting message 624 that includes the device data 622 collected from one or more IoT devices (e.g., the IoT device 320). In an embodiment of the disclosure, the reporting message 624 may include sensor data, control data, configuration data, and/or error situation information, related to the IoT devices 320. In an embodiment of the disclosure, the server 350 may transmit management information 626 based on the reporting message 624 to a remote management server 360.

In an embodiment of the disclosure, the remote management server 360 may notify an after-sales service center 602 or an IoT management center 604 (e.g., the electronic device 310, the server 350, or the user account) of the result of analyzing the management information 614 or 626, or may generate statistical data and provide the statistical data to a manufacturer 606. The result of analyzing the management information 614 or 626 may include information about error situations of the IoT device 320 or early warning information about future error situations. The after-sales service center 602 may, in response to the analysis result, identify the device state via user consultation, or provide problem resolution via remote control. The IoT management center 604 may, in response to the analysis result, provide a user with a report on the device state and an action guide. The manufacturer 606 may, based on the analysis result, detect or resolve error situations of devices released to the market.

In an embodiment of the disclosure, a home appliance (e.g., the IoT device 320) may support IoT functionality, but may lack sensor detection capabilities or include only an outdated, low-performance sensor. The IoT device 320 may be designed to include at least one sensor required to detect the state of the IoT device 320 and may include a function of collecting sensor data related to the IoT device 320 by using the at least one sensor. When the IoT device 320 is purchased and used by a user for an extended period of time, the user may experience inconvenience due to the inability to use sensor functions which employ newer technologies.

Embodiments of the disclosure may extend a sensor function of a home appliance by defining the types of sensors required based on the characteristics of the home appliance and grouping sensors around the home appliance with the home appliance. In an embodiment of the disclosure, an outdated washing machine may be design to support Wi-Fi communication technology and support only a power on/off function via Wi-Fi communication. A user can operate the wash start function and the wash stop function of the washing machine through an IoT client application to determine an operating state during washing or during the wash stop. The user may want to know additional information, such as how much time has elapsed in the washing cycle of the washing machine, how much detergent is left, or the like. Embodiments of the disclosure may group sensors (e.g., vibration sensors and/or water leak sensors), which have IoT functionality and are located around the washing machine, with the outdated washing machine, and allow the sensors to detect the operating state of the washing machine. Embodiments of the disclosure may enhance the IoT functionality of the outdated home appliance through the grouped sensors, thereby enhancing the customer experience and continuously improving the IoT experience.

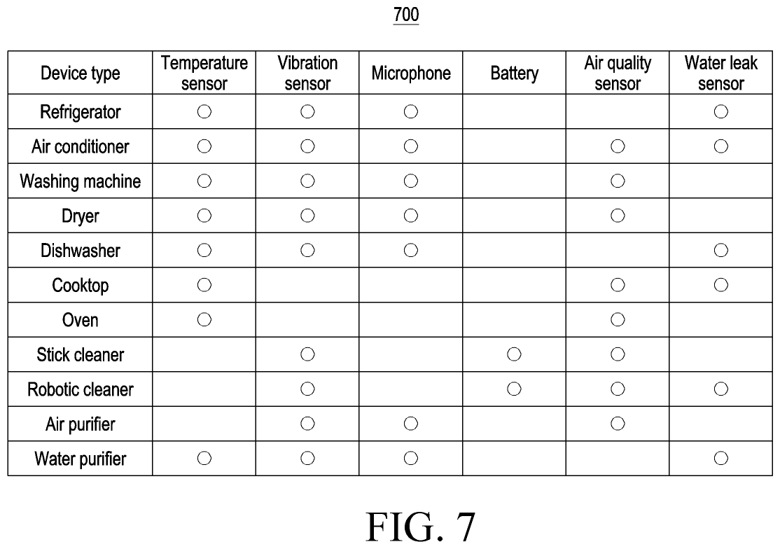

FIG. 7 illustrates a table showing sensors required according to a type of home appliance according to an embodiment of the disclosure.

Referring to FIG. 7, a table 700 may show sensors required for each of a refrigerator, an air conditioner, a washing machine, a dryer, a dishwasher, a cooktop, an oven, a stick cleaner, a robotic cleaner, an air purifier, and a water purifier. The refrigerator, the dishwasher, and the water purifier may require a temperature sensor, a vibration sensor (e.g., an axis accelerometer), a microphone, and/or a water leak sensor. The air conditioner may require a temperature sensor, a vibration sensor, a microphone, an air quality sensor (e.g., volatile organic compounds (VOC) sensors), and/or a water leak sensor. The washing machine and the dryer may require a temperature sensor, a vibration sensor, a microphone, and/or an air quality sensor. The cooktop may require a temperature sensor, an air quality sensor, and/or a water leak sensor. The oven may require a temperature sensor and/or an air quality sensor. The stick cleaner and the robotic cleaner may require a vibration sensor, a battery, and/or an air quality sensor, and the robotic cleaner may further require a water leak sensor. The air purifier may require a vibration sensor, a microphone, and/or an air quality sensor.

In an embodiment of the disclosure, when a home appliance does not include all of required sensors, IoT functionality may not be fully utilized. For example, an outdated appliance may be used without required sensors. A home appliance that lacks various sensors may only support a simple function through an IoT service, such as power on/off, and may not support a function for identifying additional states, such as a more detailed operating state and an operation time.

In an embodiment of the disclosure, when a home appliance is not equipped with various sensors, error situations may not be predictable and a user may not be able to detect the malfunction of the home appliance. For example, a washing machine equipped with a vibration sensor may detect excessive shaking and provide a self-help guide that recommends leveling to resolve the cause of the malfunction, whereas a washing machine without a vibration sensor may not detect such error situations (e.g., excessive shaking). For example, a user may want to use sensing functions that use sensors (e.g., vision sensors or lidar sensors) based on new technologies that did not exist when the appliance was sold.

Embodiments of the disclosure may group at least one sensor, which is not included in an IoT device (e.g., the IoT device 320) but is located in the vicinity of the IoT device 320, with the IoT device 320, and use the at least one grouped sensor to extend the IoT functionality of the IoT device 320 and/or to provide early warning of an error situation of the IoT device 320. For example, in a washing machine which has IoT functionality and does not include a vibration sensor and a water leak sensor, an external sensor (e.g., a vibration sensor) attached to the washing machine may be used to determine the start and end times of washing, and an external sensor (e.g., a water leak sensor) attached to a detergent container may be used to determine whether detergent has been depleted.

In an embodiment of the disclosure, the IoT device 320 may be grouped with at least one external sensor device so as to be interlocked with the at least one external sensor device. In an embodiment of the disclosure, the at least one external sensor device grouped with the IoT device 320 may be determined to be a companion device. The companion device may be selected based on proximity to the IoT device 320. In an embodiment of the disclosure, a companion device corresponding to the IoT device 320 may be physically identified based on signal strength based on a short-range communication method (e.g., Wi-Fi, BLE, UWB, or Zigbee), or may be physically identified via a USB or cable connection. In an embodiment of the disclosure, the companion device corresponding to the IoT device 320 may be identified based on a user input via a user device (e.g., the electronic device 310) related to the IoT device 320.

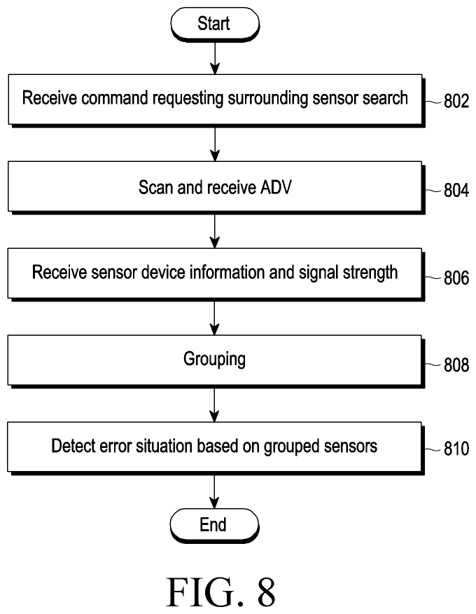

FIG. 8 is a flowchart illustrating a procedure for performing a surrounding sensor search by an IoT device according to an embodiment of the disclosure.

According to embodiments of the disclosure, at least one of operations described below may be omitted, modified, or executed in a different order. In an embodiment of the disclosure, at least one of the operations described below may be executed by a processor (e.g., the processor 412 in FIG. 4A) of the IoT device 320. In an embodiment of the disclosure, memory (e.g., the memory 416 in FIG. 4A) of the IoT device 320 may store instructions that cause the IoT device 320 to operate according to at least one of the operations described below.

Referring to FIG. 8, in operation 802, the IoT device 320 (e.g., the processor 412) may receive a command, which requests a surrounding sensor search for sensor grouping, from the electronic device 310 via communication circuitry (e.g., the communication circuitry 414 in FIG. 4A). In an embodiment of the disclosure, the electronic device 310 may execute an IoT client application and transmit the command to the IoT device 320, based on receiving, via the IoT client application, a user input requesting a surrounding sensor search of the IoT device 320. In an embodiment of the disclosure, the command may be received via a D2D connection based on Wi-Fi, Bluetooth, Zigbee, or any other short-range communication method.

In another embodiment of the disclosure, the IoT device 320 (e.g., the processor 412) may receive the command from a server (e.g., the server 350 in FIG. 3). In another embodiment of the disclosure, instead of receiving the command from the electronic device 310, the IoT device 320 (e.g., the processor 412) may receive, via an input means (e.g., a button, a touchscreen, or a microphone) of the IoT device 320, a user input requesting a surrounding sensor search for sensor grouping.

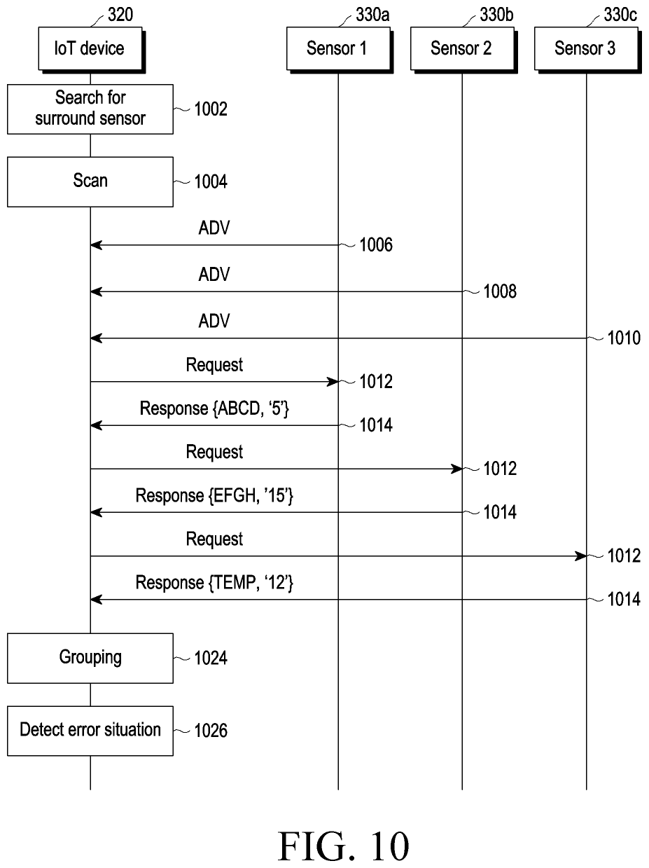

In operation 804, the IoT device 320 (e.g., the processor 412) may discover one or more external sensor devices (e.g., the sensors 330a, 330b, 330c in FIG. 10) via a designated short-range communication method (e.g., Wi-Fi, Bluetooth legacy, BLE, Zigbee, or UWB). In an embodiment of the disclosure, the IoT device 320 (e.g., the processor 412) may perform a Wi-Fi-, BLE-, or Zigbee-based scan (e.g., a page scan or BLE scan) to receive signals (e.g., beacon signals, probe signals, advertisement (ADV) packets, or corresponding response signals) broadcast from the one or more external sensor devices, and may identify the one or more external sensor devices based on receiving the signals.

In an embodiment of the disclosure, the IoT device 320 (e.g., the processor 412) may establish D2D connections (e.g., Wi-Fi/BLE/Zigbee links) with the one or more external sensor devices, based on receiving the broadcast signals.

In operation 806, the IoT device 320 (e.g., the processor 412) may receive sensor device information and/or signal strength information from the one or more external sensor devices. In an embodiment of the disclosure, the IoT device 320 (e.g., the processor 412) may transmit a request message to the one or more external sensor devices via the D2D connections and receive, based on transmitting the request message, a response message including the sensor device information and/or the signal strength information from the one or more external sensor devices.

In an embodiment of the disclosure, the sensor device information may include at least one of a device name, a device type, or a device ID of each external sensor device. In an embodiment of the disclosure, the device type may indicate the sensor type of each external sensor device (e.g., a temperature sensor, a vibration sensor, a microphone, a battery monitor, an air quality sensor, or a water leak sensor).

In an embodiment of the disclosure, the signal strength information may include a received signal strength (e.g., a received signal strength indicator (RSSI)) that each external sensor device has measured from a signal received from the IoT device 320. In an embodiment of the disclosure, instead of receiving signal strength information from each external sensor device, the IoT device 320 (e.g., the processor 412) may measure received signal strength of a signal received by the IoT device 320 from each external sensor device and generate the signal strength information including the measured received signal strength.

In operation 808, the IoT device 320 (e.g., the processor 412) may group, based on the sensor device information and the signal strength information, at least one external sensor device selected from the one or more external sensor devices with the IoT device 320. In an embodiment of the disclosure, the IoT device 320 (e.g., the processor 412) may select, from the one or more external sensor devices, at least one external sensor device that has a received signal strength greater than a designated threshold.

In an embodiment of the disclosure, based on the device type of the IoT device 320 and the sensor type indicated by the sensor device information, the IoT device 320 (e.g., the processor 412) may select at least one external sensor device that corresponds to a required sensor type for the IoT device 320. In an embodiment of the disclosure, the IoT device 320 (e.g., the processor 412) may select at least one external sensor device that corresponds to at least one sensor type and is not included in the IoT device 320.

In operation 810, the IoT device 320 (e.g., the processor 412) may determine an error situation of the IoT device 320 based on sensor data received from the at least one grouped external sensor device, or report the sensor data (or an analysis result based on the sensor data) to an external electronic device (e.g., the electronic device 310 or the server 350), thereby causing the external electronic device to determine an error situation of the IoT device 320, based on the sensor data. In an embodiment of the disclosure, the IoT device 320 (e.g., the processor 412) may provide (e.g., display or audibly output) action guide information related to the error situation, based on the error situation being detected by the sensor data. In an embodiment of the disclosure, the IoT device 320 (e.g., the processor 412) may transmit a notification of the error situation to the after-sales service center 602, the IoT management center 604, and/or the manufacturer.

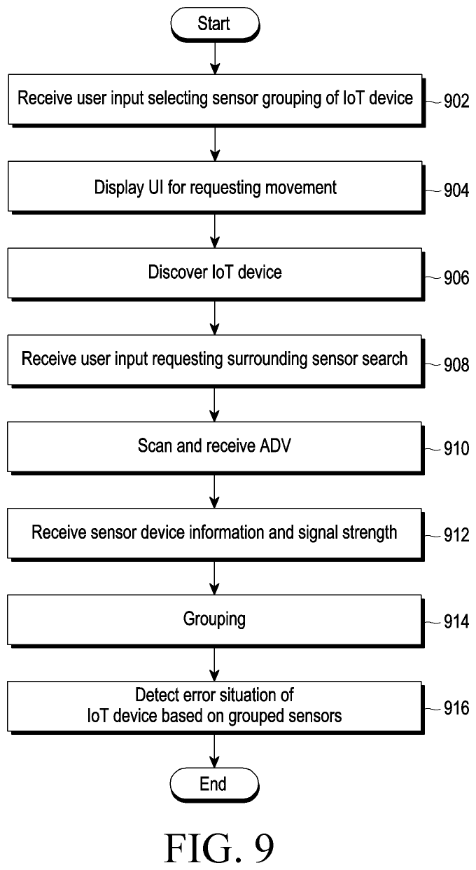

FIG. 9 is a flowchart illustrating a procedure for performing a surrounding sensor search by an electronic device according to an embodiment of the disclosure.

According to embodiments of the disclosure, at least one of operations described below may be omitted, modified, or executed in a different order. In an embodiment of the disclosure, at least one of the operations described below may be executed by a processor (e.g., the processor 220 in FIG. 2) of the electronic device 310. In an embodiment of the disclosure, memory (e.g., the memory 230 in FIG. 2) of the electronic device 310 may store instructions that cause the electronic device 310 to operate according to at least one of the operations described below.

Referring to FIG. 9, in operation 902, the electronic device 310 (e.g., the processor 220) may receive a user input requesting sensor grouping related to the IoT device 320. In an embodiment of the disclosure, the electronic device 310 (e.g., the processor 220) may execute an IoT client application and receive the user input selecting the IoT device 320 that requires an external sensor via the IoT client application. In an embodiment of the disclosure, the user input may include touching an input object (e.g., the object 514 or the device symbol 526) corresponding to the IoT device 320 on an execution screen (e.g., the dashboard screen 510 in FIG. 5A or the map view screen 520 in FIG. 5B) of the IoT client application. In an embodiment of the disclosure, the user input may include touching an input object that indicates a need for sensor grouping.

In operation 904, the electronic device 310 (e.g., the processor 220) may display, based on receiving the user input, a user interface (e.g., a guide message, “Please move to the vicinity of the washing machine”) requesting movement to the vicinity of the IoT device 320. In an embodiment of the disclosure, the electronic device 310 (e.g., the processor 220) may omit operations 904 and 906 and proceed to operation 910 when it is determined that the electronic device 310 is located in the vicinity of the IoT device 320, based on receiving a signal (e.g., a beacon signal, a probe signal, an advertisement packet, or a corresponding response signal) broadcast from the IoT device 320 at the time a surrounding sensor search is requested, or based on identifying that a D2D connection with the IoT device 320 has been established.

In operation 906, to identify that the electronic device 310 is located in the vicinity of the IoT device 320, the electronic device 310 (e.g., the processor 220) may discover the IoT device 320 based on receiving a signal broadcast from the IoT device 320 using a short-range communication method (e.g., Wi-Fi, BLE, or Zigbee). In an embodiment of the disclosure, the electronic device 310 (e.g., the processor 220) may establish a D2D connection (e.g., a Wi-Fi/BLE/Zigbee connection) with the IoT device 320. The electronic device 310 (e.g., the processor 220) may receive device information (e.g., a device ID) of the IoT device 320 from the IoT device 320 via the D2D connection.

In operation 908, the electronic device 310 (e.g., the processor 220) may receive a user input requesting a surrounding sensor search for the IoT device 320. In an embodiment of the disclosure, the electronic device 310 (e.g., the processor 220) may, after discovering the IoT device 320 and/or establishing a D2D connection with the IoT device 320, display a user interface (e.g., a guide message “Would you like to search for external sensors?”) to inquire whether to perform a surrounding sensor search, and receive the user input requesting the surrounding sensor search via the user interface. In an embodiment of the disclosure, operation 908 may be omitted, and the electronic device 310 (e.g., the processor 220) may proceed to operation 910 without any user input after discovering the IoT device 320.

In operation 910, the electronic device 310 (e.g., the processor 220) may discover one or more external sensor devices (e.g., the sensors 330a, 330b, 330c in FIG. 10) via a designated short-range communication method (e.g., Wi-Fi, BLE, or ZigBee). In an embodiment of the disclosure, the electronic device 310 (e.g., the processor 220) may perform a Wi-Fi, BLE, or ZigBee-based scan (e.g., a page scan or a BLE scan) to receive signals (e.g., advertisement (ADV) packets) broadcast from the one or more external sensor devices, and may identify the one or more external sensor devices based on receiving the signals.

In an embodiment of the disclosure, the electronic device 310 (e.g., the processor 220) may establish, based on receiving the broadcasted signals, D2D connections (e.g., Bluetooth links) with the one or more external sensor devices.

In operation 912, the electronic device 310 (e.g., the processor 220) may receive sensor device information and/or signal strength information from the one or more external sensor devices. In an embodiment of the disclosure, the electronic device 310 (e.g., the processor 220) may transmit a request message to the one or more external sensor devices via the D2D connections and may receive, based on transmitting the request message, a response message including the sensor device information and/or the signal strength information from the one or more external sensor devices.

In an embodiment of the disclosure, the sensor device information may include at least one of a device name, a device type, or a device ID of each external sensor device. In an embodiment of the disclosure, the device type may indicate the sensor type of each external sensor device (e.g., a temperature sensor, a vibration sensor, a microphone, a battery monitor, an air quality sensor, or a water leak sensor).

In an embodiment of the disclosure, the signal strength information may include a received signal strength (e.g., RSSI) that each external sensor device has measured from the signal received from the electronic device 310. In an embodiment of the disclosure, instead of receiving signal strength information from each external sensor device, the electronic device 310 (e.g., the processor 220) may measure the received signal strength of a signal received by the electronic device 310 from each external sensor device and generate the signal strength information including the measured received signal strength.

In operation 914, the electronic device 310 (e.g., the processor 220) may group at least one external sensor device selected from the one or more external sensor devices with the IoT device 320, based on the sensor device information and the signal strength information. In an embodiment of the disclosure, the electronic device 310 (e.g., the processor 220) may select at least one external sensor device, which has a received signal strength greater than a designated threshold, from the one or more external sensor devices.

In an embodiment of the disclosure, the electronic device 310 (e.g., the processor 220) may select at least one external sensor device that corresponds to a required sensor type for the IoT device 320, based on the device type of the IoT device 320 and the sensor type indicated by the sensor device information. In an embodiment of the disclosure, the electronic device 310 (e.g., the processor 220) may select at least one external sensor device that corresponds to at least one sensor type and is not included in the IoT device 320. In an embodiment of the disclosure, when there are multiple external sensor devices with the same sensor type, the electronic device 310 (e.g., the processor 220) may select and group one external sensor device having the greatest signal strength.

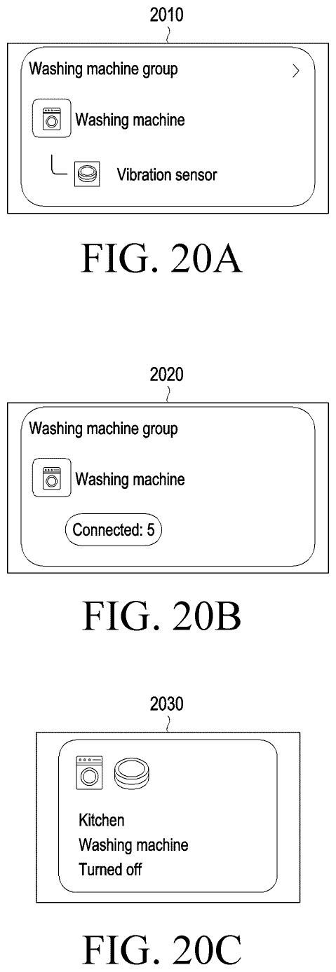

In an embodiment of the disclosure, the electronic device 310 (e.g., the processor 220) may display a user interface (e.g., the user interface 2010 in FIG. 20A, the user interface 2020 in FIG. 20B, or the user interface 2030 in FIG. 20C) representing the at least one external sensor device grouped with the IoT device 320.

In operation 916, the electronic device 310 (e.g., the processor 220) may determine an error situation of the IoT device 320, based on sensor data received from the at least one grouped external sensor device, or may report the sensor data (or an analysis result based on the sensor data) to an external electronic device (e.g., the IoT device 320 or the server 350). In an embodiment of the disclosure, the electronic device 310 (e.g., the processor 220) may provide (e.g., display, or audibly output) action guide information related to the error situation, based on the error situation being detected by the sensor data. In an embodiment of the disclosure, the electronic device 310 (e.g., the processor 220) may transmit a notification of the error situation to the after-sales service center 602, the IoT management center 604, and/or the manufacturer 606.

FIG. 10 is a sequence diagram illustrating a surrounding sensor search and sensor grouping according to an embodiment of the disclosure.

According to embodiments of the disclosure, at least one of operations described below may be omitted, modified, or executed in a different order.

Referring to FIG. 10, in operation 1002, an IoT device 320 may receive a command or a user input requesting a surrounding sensor search for sensor grouping. In an embodiment of the disclosure, the command may be received from a server (e.g., the server 350 in FIG. 3) via the internet, or from an electronic device (e.g., the electronic device 310 in FIG. 3) via a D2D connection. In operation 1004, the IoT device 320 may perform a scan (e.g., a page scan or a BLE scan) for a surrounding sensor search, based on receiving the command or the user input.

In operations 1006, 1008, and 1010, the IoT device 320 may discover sensor 1 330a, sensor 2 330b, and sensor 3 330c based on receiving signals (e.g., beacon signals, probe signals, advertisement packets, or corresponding response signals) broadcast from the sensor 1 330a, the sensor 2 330b, and the sensor 3 330c, respectively. In an embodiment of the disclosure, the sensor 1 330a may be vibration sensor 1 having a device ID of ABCD, the sensor 2 330b may be a vibration sensor 2 having a device ID of EFGH, and the sensor 3 330c may be a temperature sensor having a device ID of TEMP. In an embodiment of the disclosure, the IoT device 320 may establish a D2D connection with each of the sensor 1 330a, the sensor 2 330b, and the sensor 3 330c, based on receiving the broadcast signals.

In operation 1012, the IoT device 320 may transmit a request message to the sensor 1 330a to request sensor device information and signal strength information. In operation 1014, the IoT device 320 may receive, from the sensor 1 330a, a response message that includes the sensor device information and the signal strength information. In an embodiment of the disclosure, the sensor device information may include a device name=“Vibration Sensor 1,” a device type=“Axis,” and a device ID=“ABCD.” In an embodiment of the disclosure, the signal strength information may include a quantized signal strength value, such as “5.”

In operation 1016, the IoT device 320 may transmit a request message to the sensor 2 330a to request sensor device information and signal strength information. In operation 1018, the IoT device 320 may receive, from the sensor 2 330b, a response message that includes the sensor device information and the signal strength information. In an embodiment of the disclosure, the sensor device information may include a device name=“Vibration Sensor 2,” a device type=“Axis,” and a device ID=“EFGH.” In an embodiment of the disclosure, the signal strength information may include a quantized signal strength value, such as “15.”

In operation 1020, the IoT device 320 may transmit a request message to the sensor 3 330c to request sensor device information and signal strength information. In operation 1022, the IoT device 320 may receive, from the sensor 3 330c, a response message that includes the sensor device information and the signal strength information. In an embodiment of the disclosure, the sensor device information may include a device name=“temperature sensor,” a device type=“Temperature,” and a device ID=“TEMP.” In an embodiment of the disclosure, the signal strength information may include a quantized signal strength value, such as “12.”

In operation 1024, the IoT device 320 may select at least one sensor (e.g., the sensor 2 330b and the sensor 3 330c) to be grouped with the IoT device 320, based on the sensor device information and signal strength information of each of the sensor 1 330a, the sensor 2 330b, and the sensor 3 330c, and may group the sensor 2 330b and the sensor 3 330c with the IoT device 320. In an embodiment of the disclosure, the IoT device 320 may select at least one sensor having a signal strength greater than a designated threshold (e.g., “10”). In an embodiment of the disclosure, the IoT device 320 may select the at least one sensor having sensor types (e.g., vibration sensor and/or temperature sensor) that corresponds to the device type (e.g., “washing machine”) of the IoT device 320. In an embodiment of the disclosure, the IoT device 320 may exclude, from sensor grouping, a sensor type of a built-in sensor that the IoT device 320 already includes (e.g., a water leak sensor).

In an embodiment of the disclosure, the at least one sensor (e.g., the sensor 2 330b and the sensor 3 330c) selected via grouping may be companion devices corresponding to the IoT device 320. The IoT device 320 may store grouping information including a device ID (e.g., “DA1”) of the IoT device 320 and companion device information (e.g., [EFGH, TEMP]). In an embodiment of the disclosure, the IoT device 320 may report the grouping information to an external electronic device (e.g., the electronic device 310 and/or the server 350).

In operation 1026, the IoT device 320 may determine whether an error situation of the IoT device 320 has occurred, based on sensor data collected via the companion devices (e.g., the sensor 2 330b and the sensor 3 330c). In an embodiment of the disclosure, the IoT device 320 may receive sensor data from the sensor 2 330b and sensor 3 330c periodically or in response to a request, and analyze the sensor data to determine whether an error situation of IoT device 320 has occurred or whether an early warning has been generated. In an embodiment of the disclosure, the IoT device 320 may report the sensor data or a corresponding analysis result to an external electronic device (e.g., the electronic device 310 and/or the server 350). In an embodiment of the disclosure, the IoT device 320 may provide (e.g., display or audibly output), to a user, a report and an action guide based on the sensor data or the corresponding analysis result.

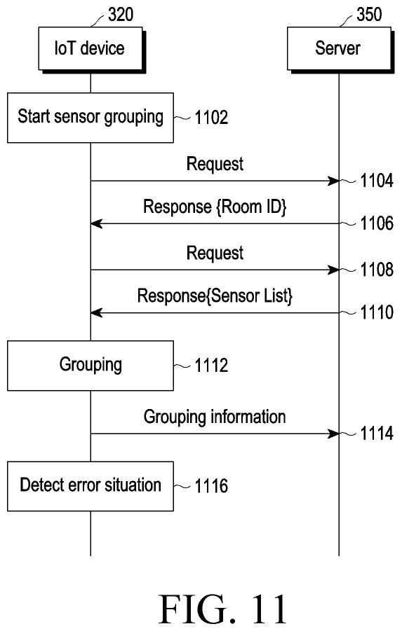

FIG. 11 is a sequence diagram illustrating sensor grouping based on a sensor list according to an embodiment of the disclosure.

According to embodiments of the disclosure, at least one of operations described below may be omitted, modified, or executed in a different order.

Referring to FIG. 11, in operation 1102, an IoT device 320 may receive a command or a user input requesting sensor grouping. In an embodiment of the disclosure, the command may be received from a server (e.g., server 350 in FIG. 3) via the internet, or from an electronic device (e.g., the electronic device 310 in FIG. 3) via a D2D connection.

In operation 1104, the IoT device 320 may transmit a request message to the server 350 to request location information of the IoT device 320. In an embodiment of the disclosure, the server 350 may identify, based on the request message, location information indicating a location (e.g., room ID=“kitchen”) where the IoT device 320 is installed. In operation 1106, the server 350 may transmit a response message including the location information to the IoT device 320.

In operation 1108, the IoT device 320 may transmit a request message including the location information (e.g., room ID=“kitchen”) to the server 350 to request information about sensors located in the vicinity of the IoT device 320. In an embodiment of the disclosure, the server 350 may generate, based on the request message, a sensor list including at least one sensor located in the vicinity of the IoT device 320. In an embodiment of the disclosure, the sensor list may include a device name, a device type, a device ID, and/or a medium access control (MAC) address of each of the at least one sensor.

In an embodiment of the disclosure, the server 350 may identify at least one room proximate to a kitchen (e.g., utility room and room 3) and include, in the sensor list, at least one sensor located within the kitchen and/or at least one sensor located within the at least one identified room. In an embodiment of the disclosure, the server 350 may include, in the sensor list, at least one sensor having a sensor type that is required based on a device type (e.g., “washing machine”) of the IoT device 320. In an embodiment of the disclosure, the server 350 may not include, in the sensor list, a sensor type (e.g., a water leak sensor) of a built-in sensor that the IoT device 320 already includes.

In operation 1110, the server 350 may transmit a response message including the sensor list to the IoT device 320. In an embodiment of the disclosure, the IoT device 320 may transmit a single, consolidated request message instead of the request messages in operations 1104 and 1108, and receive the sensor list from the server 350.

In operation 1112, the IoT device 320 may group at least one sensor (e.g., the sensor 2 330b and the sensor 3 330c) included in the sensor list with the IoT device 320. The IoT device 320 may store grouping information including a device ID (e.g., “DA1”) of the IoT device 320 and companion device information indicating the at least one sensor.

In operation 1114, the IoT device 320 may report the grouping information to an external electronic device (e.g., the electronic device 310 and/or the server 350). In an embodiment of the disclosure, the IoT device 320 may establish a D2D connection (e.g., a Wi-Fi connection or a Bluetooth connection) with the at least one sensor, based on information included in the sensor list.

In operation 1116, the IoT device 320 may determine whether an error situation of the IoT device 320 has occurred, based on sensor data collected through the at least one sensor based on the grouping information. In an embodiment of the disclosure, the IoT device 320 may receive sensor data from the at least one sensor periodically or in response to a request, and analyze the sensor data to determine whether an error situation of the IoT device 320 has occurred or whether an early warning has been generated. In an embodiment of the disclosure, the IoT device 320 may report the sensor data or a corresponding analysis result to an external electronic device (e.g., the electronic device 310 and/or the server 350). In an embodiment of the disclosure, the IoT device 320 may provide (e.g., display or audibly output), to a user, a report and an action guide based on the sensor data or the corresponding analysis result.

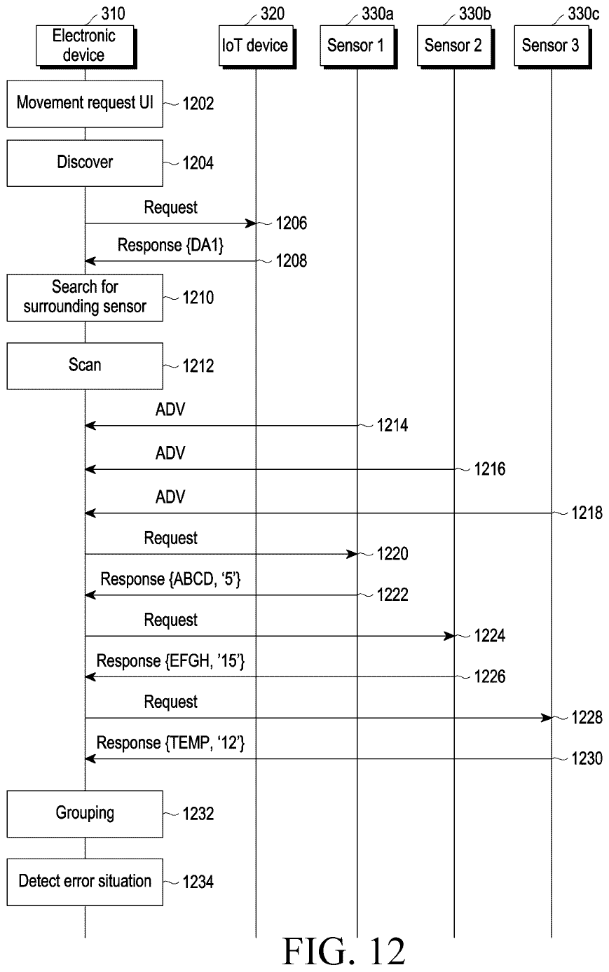

FIG. 12 is a sequence diagram illustrating a surrounding sensor search and sensor grouping according to an embodiment of the disclosure.

According to embodiments of the disclosure, at least one of operations described below may be omitted, modified, or executed in a different order.

Referring to FIG. 12, in operation 1202, an electronic device 310 may display a user interface (UI) that includes a guide message (e.g., “Please move to the vicinity of a washing machine”) requesting movement to the vicinity of an IoT device 320 for the purpose of sensor grouping. In an embodiment of the disclosure, the electronic device 310 may display the user interface, based on a user input requesting sensor grouping via an IoT client application. In an embodiment of the disclosure, the user input may include touching an input object (e.g., the object 514 or the device symbol 526) corresponding to the IoT device 320 on a dashboard screen (e.g., the dashboard screen 510 in FIG. 5A) or a map view screen (e.g., the map view screen 520 in FIG. 5B). In an embodiment of the disclosure, the user input may include touching an input object that indicates a need for sensor grouping.

In operation 1204, the electronic device 310 (e.g., the processor 220) may discover the IoT device 320, based on receiving a signal (e.g., a beacon signal, a probe signal, an advertisement packet, or a corresponding response signal) broadcast from the IoT device 320 in order to determine that the electronic device 310 is located in the vicinity of the IoT device 320. In an embodiment of the disclosure, the electronic device 310 (e.g., the processor 220) may establish a D2D connection (e.g., a Wi-Fi connection or a Bluetooth connection) with the IoT device 320.

In operation 1206, the electronic device 310 may transmit a request message to the IoT device 320 via the D2D connection to request device information.

In operation 1208, the electronic device 310 may receive a response message including device information of the IoT device 320 in response to the request message. In an embodiment of the disclosure, the device information may include a device name=“Washing Machine SS,” a device type=“Washer,” and a device ID=“DA1.”

In operation 1210, the electronic device 310 may receive a user input requesting a surrounding sensor search for the IoT device 320.

In operation 1212, the electronic device 310 (e.g., the processor 220) may, after establishing a D2D connection with the IoT device 320, display a user interface (e.g., a guide message “Would you like to search for an external sensor?”) for inquiring whether to perform a surrounding sensor search, and receive the user input requesting the surrounding sensor search via the user interface.

In operations 1214, 1216, and 1218, the electronic device 310 may discover sensor 1 330a, sensor 2 330b, and sensor 3 330c based on receiving signals (e.g., beacon signals, probe signals, advertisement packets, or corresponding response signals) broadcast from the sensor 1 330a, the sensor 2 330b, and the sensor 3 330c, respectively. In an embodiment of the disclosure, the sensor 1 330a may be vibration sensor 1 having a device ID of ABCD, the sensor 2 330b may be a vibration sensor 2 having a device ID of EFGH, and the sensor 3 330c may be a temperature sensor having a device ID of TEMP. In an embodiment of the disclosure, the electronic device 310 may establish D2D connections with the sensor 1 330a, the sensor 2 330b, and the sensor 3 330c, based on receiving the broadcast signals.

In operation 1220, the electronic device 310 may transmit a request message to the sensor 1 330a to request sensor device information and signal strength information. In operation 1222, the electronic device 310 may receive, from the sensor 1 330a, a response message including the sensor device information and the signal strength information. In an embodiment of the disclosure, the sensor device information may include a device name=“Vibration Sensor 1,” a device type=“Axis,” and a device ID=“ABCD.” In an embodiment of the disclosure, the signal strength information may include a quantized signal strength value, such as “5.”

In operation 1224, the electronic device 310 may transmit a request message to the sensor 2 330a to request sensor device information and signal strength information.

In operation 1226, the electronic device 310 may receive, from the sensor 2 330b, a response message including sensor device information and signal strength information. In an embodiment of the disclosure, the sensor device information may include a device name=“Vibration Sensor 2,” a device type=“Axis,” and a device ID=“EFGH.” In an embodiment of the disclosure, the signal strength information may include a quantized signal strength value, such as “15.”

In operation 1228, the electronic device 310 may transmit a request message to the sensor 3 330c to request sensor device information and signal strength information.

In operation 1230, the electronic device 310 may receive, from the sensor 3 330c, a response message including the sensor device information and the signal strength information. In an embodiment of the disclosure, the sensor device information may include a device name=“Temperature Sensor,” a device type=“Temperature,” and a device ID=“TEMP.” In an embodiment of the disclosure, the signal strength information may include a quantized signal strength value, such as “12.”

In operation 1232, the electronic device 310 may select at least one sensor (e.g., the sensor 2 330b and the sensor 3 330c) to be grouped with the IoT device 320, based on the sensor device information and the signal strength information of each of the sensor 1 330a, the sensor 2 330b, and the sensor 3 330c, and may group the sensor 2 330b and the sensor 3 330c with the IoT device 320. In an embodiment of the disclosure, the electronic device 310 may select at least one sensor having a signal strength greater than a designated threshold (e.g., “10”). In an embodiment of the disclosure, the electronic device 310 may select the at least one sensor having a sensor type (e.g., vibration sensor and/or temperature sensor) that corresponds to a device type (e.g., “washing machine”) of the IoT device 320. In an embodiment of the disclosure, the electronic device 310 may exclude, from the sensor grouping, a sensor type (e.g., a water leak sensor) of built-in a sensor that the IoT device 320 already includes.

In an embodiment of the disclosure, the at least one sensor (e.g., the sensor 2 330b and the sensor 3 330c) selected through grouping may be companion devices corresponding to the IoT device 320. The electronic device 310 may store grouping information including a device ID (e.g., “DA1”) of the IoT device 320 and companion device information (e.g., [EFGH, TEMP]). In an embodiment of the disclosure, the electronic device 310 may report the grouping information to the server 350.

In operation 1234, the electronic device 310 may determine whether an error situation of the IoT device 320 has occurred, based on sensor data collected via the companion devices (e.g., the sensor 2 330b and the sensor 3 330c). In an embodiment of the disclosure, the electronic device 310 may receive sensor data from the sensor 2 330b and the sensor 3 330c periodically or in response to a request, and analyze the sensor data to determine whether an error situation of the IoT device 320 has occurred or whether an early warning has been generated. In an embodiment of the disclosure, the electronic device 310 may report the sensor data or a corresponding analysis result to the server 350. In an embodiment of the disclosure, the electronic device 310 may provide (e.g., display or audibly output), to a user, a report and an action guide based on the sensor data or the corresponding analysis result.

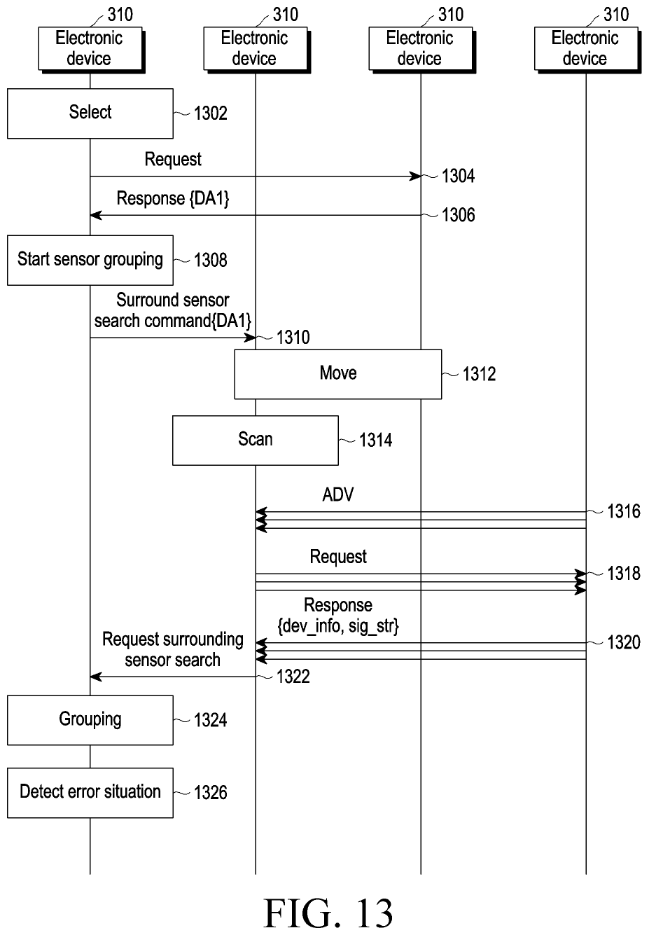

FIG. 13 is a sequence diagram illustrating a surrounding sensor search using a mobile device according to an embodiment of the disclosure.

According to embodiments of the disclosure, at least one of operations described below may be omitted, modified, or executed in a different order.

Referring to FIG. 13, in operation 1302, an electronic device 310 may receive a user input for selecting an IoT device 320 for performing sensor grouping. In an embodiment of the disclosure, the electronic device 310 may receive the user input via an IoT client application. In an embodiment of the disclosure, the user input may include touching an input object (e.g., the object 514 or the device symbol 526) corresponding to the IoT device 320 on a dashboard screen (e.g., the dashboard screen 510 in FIG. 5A) or a map view screen (e.g., the map view screen 520 in FIG. 5B). In an embodiment of the disclosure, the user input may include touching an input object that indicates a need for sensor grouping.

In an embodiment of the disclosure, the electronic device 310 (e.g., the processor 220) may establish a D2D connection (e.g., a Wi-Fi connection or a Bluetooth connection) with the IoT device 320 based on receiving a signal (e.g., a beacon signal, a probe signal, an advertisement packet, or a corresponding response signal) broadcast from the IoT device 320.

In operation 1304, the electronic device 310 may transmit a request message to the IoT device 320 via the D2D connection to request device information.

In operation 1306, the electronic device 310 may receive a response message including device information of the IoT device 320 in response to the request message. In an embodiment of the disclosure, the device information may include a device name=“WasherSS,” a device type=“Washer,” and a device ID=“DA1.”

In operation 1308, the electronic device 310 may receive a user input requesting a surrounding sensor search for the IoT device 320. In an embodiment of the disclosure, the electronic device 310 (e.g., the processor 220) may, after establishing a D2D connection with the IoT device 320, display a user interface (e.g., a guide message “Would you like to search for external sensors by a robotic cleaner?”) for inquiring whether to perform a surrounding sensor search via a mobile IoT device 320f, and receive the user input requesting a surrounding sensor search via the user interface.

In operation 1310, the electronic device 310 may transmit, to the mobile IoT device 320f, a surrounding sensor search command to perform a surrounding sensor search for the IoT device 320. In an embodiment of the disclosure, the surrounding sensor search command may include information indicating a location (e.g., room ID=“kitchen”) of the IoT device 320 and/or a device ID of the IoT device 320 (e.g., “DA1”).

In operation 1312, the mobile IoT device 320f may move to the vicinity (e.g., kitchen) of the IoT device 320 in response to the surrounding sensor search command. In an embodiment of the disclosure, the mobile IoT device 320f may identify, based on a pre-stored map, a room in which the IoT device 320 is located.

In operation 1314, the mobile IoT device 320f may perform, based on arriving in the vicinity (e.g., kitchen) of the IoT device 320, a scan (e.g., a page scan or BLE scan) for a surrounding sensor search via a designated short-range communication method (e.g., Wi-Fi, BLE, or Zigbee).

In operation 1316, the mobile IoT device 320f may discover sensor 1 330a, sensor 2 330b, and sensor 3 330c based on receiving signals (e.g., beacon signals, probe signals, advertisement packets, or corresponding response signals) broadcast from the sensor 1 330a, the sensor 2 330b, and the sensor 3 330c, respectively. In an embodiment of the disclosure, the sensor 1 330a may be vibration sensor 1 having a device ID of ABCD, the sensor 2 330b may be vibration sensor 2 having a device ID of EFGH, and the sensor 3 330c may be a temperature sensor having a device ID of TEMP. In an embodiment of the disclosure, the mobile IoT device 320f may establish D2D connections with the sensor 1 330a, the sensor 2 330b, and the sensor 3 330c, based on receiving the above broadcast signals.

In operation 1318, the mobile IoT device 320f may transmit a request message to each of the sensor 1 330a, the sensor 2 330b, and the sensor 3 330c to request sensor device information and signal strength information.

In operation 1320, the mobile IoT device 320f may receive a response message including sensor device information (dev_info) and signal strength information (sig_str) from each of the sensor 1 330a, the sensor 2 330b, and the sensor 3 330c.

In operation 1322, the mobile IoT device 320f may transmit, to the electronic device 310, a sensor information response message that includes sensor device information and signal strength information of the sensor 1 330a, the sensor 2 330b, and the sensor 3 330c.

In operation 1324, the electronic device 310 may select at least one sensor (e.g., the sensor 2 330b and the sensor 3 330c) to be grouped with the IoT device 320, based on the sensor device information and the signal strength information of each of the sensor 1 330a, the sensor 2 330b, and the sensor 3 330c, and may group the sensor 2 330b and the sensor 3 330c with the IoT device 320. In an embodiment of the disclosure, the electronic device 310 may select at least one sensor having a signal strength greater than a designated threshold (e.g., “10”). In an embodiment of the disclosure, the electronic device 310 may select at least one sensor having a sensor type (e.g., vibration sensor and/or temperature sensor) that corresponds to a device type (e.g., “washing machine”) of the IoT device 320. In an embodiment of the disclosure, the electronic device 310 may exclude, from the sensor grouping, a sensor type (e.g., a water leak sensor) of a built-in sensor that the IoT device 320 already includes.

In an embodiment of the disclosure, the at least one sensor (e.g., sensor 2 330b and sensor 3 330c) selected through grouping may be companion devices corresponding to the IoT device 320. The electronic device 310 may store grouping information including a device ID (e.g., “DA1”) of the IoT device 320 and companion device information (e.g., [EFGH, TEMP]). In an embodiment of the disclosure, the electronic device 310 may report the grouping information to a server 350.

In operation 1326, the electronic device 310 may determine whether an error situation of the IoT device 320 has occurred, based on sensor data collected via the companion devices (e.g., the sensor 2 330b and the sensor 3 330c). In an embodiment of the disclosure, the electronic device 310 may receive sensor data from the sensor 2 330b and the sensor 3 330c periodically or in response to a request, and analyze the sensor data to determine whether an error situation of the IoT device 320 has occurred or whether an early warning has been generated. In an embodiment of the disclosure, the electronic device 310 may report the sensor data or a corresponding analysis result to the server 350. In an embodiment of the disclosure, the electronic device 310 may provide (e.g., display or audibly output), to a user, a report and an action guide based on the sensor data or the corresponding analysis result.

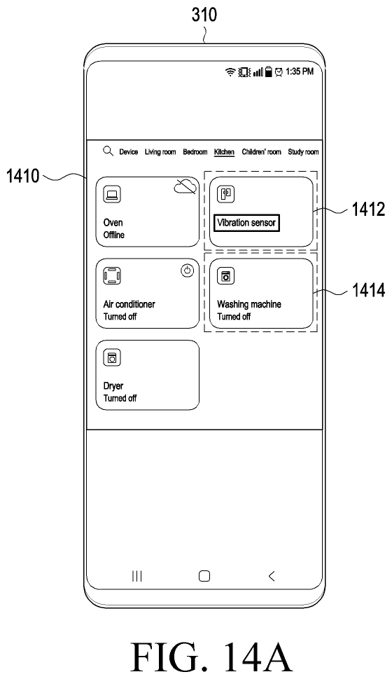

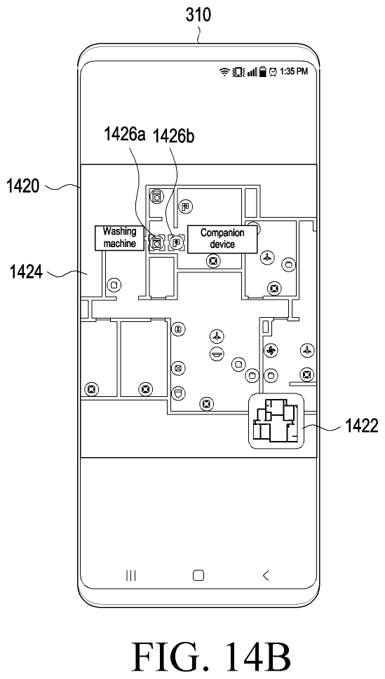

FIGS. 14A and 14B illustrate the selection of sensors according to various embodiments of the disclosure.

Referring to FIG. 14A, an electronic device 310 may execute an IoT client application for an IoT service and display a dashboard screen 1410 via a display module (e.g., the display module 260), based on the execution of the client application. The dashboard screen 1410 may include objects (e.g., objects 1412 and 1414) corresponding to one or more onboarded IoT devices (e.g., an oven, an air conditioner, a dryer, a vibration sensor, and a washing machine). In an embodiment of the disclosure, the objects may be arranged in the form of a tile grid.

In an embodiment of the disclosure, the dashboard screen 1410 may include one (e.g., a page corresponding to a kitchen) of multiple pages respectively corresponding to multiple rooms corresponding to a local network (e.g., the local network 345 in FIG. 3) for IoT services. The electronic device 310 may use the dashboard screen 1410, which includes the objects 1412 and 1414, to allow a user to recognize that a vibration sensor corresponding to the object 1412 is located in the vicinity of a washing machine corresponding to the object 1414.

In an embodiment of the disclosure, the electronic device 310 may determine to group the vibration sensor corresponding to the object 1412 with the washing machine corresponding to the object 1414, based on receiving a user input (e.g., consecutive touches on the objects 1412 and 1414) requesting the grouping of the objects 1412 and 1414 should be grouped for sensor grouping.

Referring to FIG. 14B, an electronic device 310 may execute a client application for an IoT control service and display a map view screen 1420 via a display module (e.g., the display module 260), based on the execution of the client application. The map view screen 1420 may include a simplified map image 1422 corresponding to a local network (e.g., the local network 345 in FIG. 3), and a detailed map image 1424 including an expanded image of at least a partial region in the simplified map image 1422.

In an embodiment of the disclosure, the simplified map image 1422 may represent a building structure (e.g., floor plan) corresponding to a local network (e.g., local network 345 in FIG. 3) for an IoT service and including multiple rooms. In an embodiment of the disclosure, the detailed map image 1424 may represent a partial floor plan corresponding to a partial region in the simplified map image 1422 and may include device symbols (e.g., device symbols 1426a and 1426b) displayed on the partial floor plan. In an embodiment of the disclosure, each device symbol may be placed at a virtual location on the detailed map image 1424 that corresponds to a location (e.g., a kitchen) where a corresponding actual IoT device (e.g., a washing machine and a vibration sensor) is installed. In an embodiment of the disclosure, the device symbol 1426a may correspond to a washing machine placed in a kitchen, and the device symbol 1426b may correspond to a vibration sensor located in the vicinity of the washing machine placed in a kitchen.

In an embodiment of the disclosure, the electronic device 310 may use the map view screen 1420, including the device symbols 1426a and 1426b, to enable a user to recognize that the vibration sensor corresponding to the device symbol 1426b is located in the vicinity of the washing machine corresponding to the device symbol 1426a. In an embodiment of the disclosure, the electronic device 310 may determine to group the vibration sensor corresponding to the device symbol 1426b with the washing machine corresponding to the device symbol 1426a, based on receiving a user input (e.g., consecutive touches on the device symbols 1426a and 1426b) requesting the grouping of the device symbols 1426a and 1426b for sensor grouping.

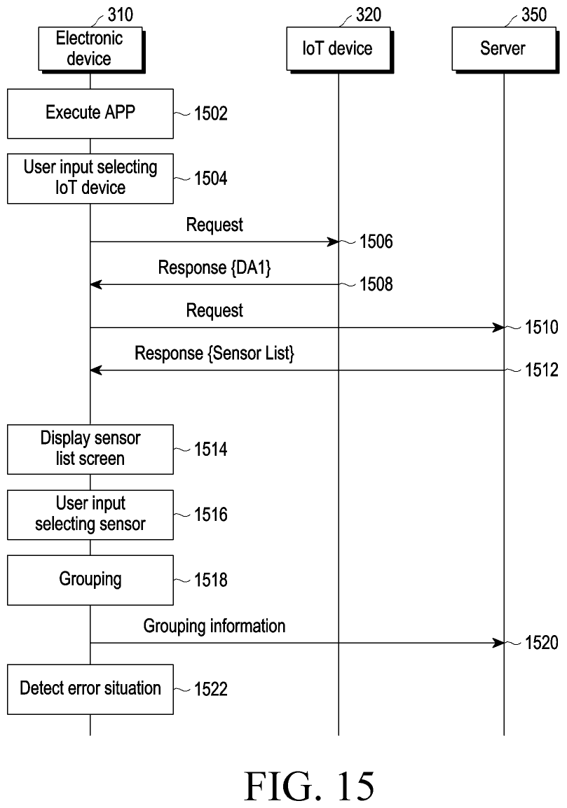

FIG. 15 is a sequence diagram illustrating a procedure for selecting a sensor to be grouped according to an embodiment of the disclosure.

According to embodiments of the disclosure, at least one of operations described below may be omitted, modified, or executed in a different order.

Referring to FIG. 15, in operation 1502, an electronic device 310 may execute an IoT client application. In an embodiment of the disclosure, the electronic device 310 may display an IoT client application execution screen (e.g., the dashboard screen 1410 in FIG. 14A or the map view screen 1420 in FIG. 14B), based on the execution of the IoT client application.

In operation 1504, the electronic device 310 may receive, via the execution screen, user input for selecting an IoT device (e.g., the IoT device 320) that is to be grouped with external sensor devices. In an embodiment of the disclosure, the user input may include touching an object (e.g., the object 1414 in FIG. 14A or the device symbol 1426a in FIG. 14B) corresponding to the IoT device 320. In an embodiment of the disclosure, the electronic device 310 may establish, based on the user input, a D2D connection with the IoT device 320.

In operation 1506, the electronic device 310 may transmit a request message to the IoT device 320 via the D2D connection to request device information.

In operation 1508, the electronic device 310 may receive a response message including device information of the IoT device 320 in response to the request message. In an embodiment of the disclosure, the device information may include a device name=“WasherSS,” a device type=“Washer,” and a device ID=“DA1.” In an embodiment of the disclosure, when the electronic device 310 already knows the device information of the IoT device 320, operations 1506 and 1508 may be omitted.

In operation 1510, the electronic device 310 may transmit a request message to a server 350 to request information from external sensor devices related to the IoT device 320. In an embodiment of the disclosure, the request message may include device information (e.g., device ID) of the IoT device 320 and/or location information (e.g., room ID) of the IoT device 320.

In operation 1512, the electronic device 310 may receive, in response to the request message, a response message including sensor device information of one or more external sensor devices (e.g., the sensor 1 330a, the sensor 2 330b, and the sensor 3 330c in FIG. 10).

In an embodiment of the disclosure, the sensor device information may include at least one of a device name, a device type, or a device ID of each external sensor device. In an embodiment of the disclosure, the device type may indicate the sensor type (e.g., temperature sensor, vibration sensor, microphone, battery monitor, air quality sensor, or water leak sensor) of each external sensor device.

In an embodiment of the disclosure, if the electronic device 310 already knows at least one external sensor device located in the vicinity of the IoT device 320 (e.g., in the same room), operations 1510 and 1512 may be omitted.

In operation 1514, the electronic device 310 may display a sensor list screen showing one or more external sensor devices identified as being located in the vicinity of the IoT device 320. In an embodiment of the disclosure, the sensor list screen may include one or more objects (e.g., the object 1412 in FIG. 14A or the device symbol 1426b in FIG. 14B) corresponding to the one or more external sensor devices.

In operation 1516, the electronic device 310 may receive, via the sensor list screen, a user input selecting at least one external sensor device from the one or more external sensor devices. The user input may include touching at least one object (e.g., the object 1412 in FIG. 14A or the device symbol 1426b in FIG. 14B) corresponding to the at least one external sensor device.

In operation 1518, the electronic device 310 may group the at least one selected external sensor device with the IoT device 320. In an embodiment of the disclosure, the electronic device 310 may collect signal strength information of the at least one external sensor device selected by the user input, and may exclude, from the sensor grouping, an external sensor device having a signal strength that is not greater than a designated threshold. In an embodiment of the disclosure, the electronic device 310 may exclude, from the sensor grouping, a sensor, which does not have a sensor type (e.g., vibration sensor and/or temperature sensor) corresponding to a device type (e.g., “washing machine”) of the IoT device 320, among the at least one external sensor device selected by the user input. In an embodiment of the disclosure, the electronic device 310 may exclude, from the sensor grouping, a sensor, which has a sensor type of a built-in sensor already included in the IoT device 320, among the at least one external sensor device selected by the user input.

In an embodiment of the disclosure, the at least one grouped sensor (e.g., the sensor 2 330b and the sensor 3 330c in FIG. 10) may be companion devices corresponding to the IoT device 320. The electronic device 310 may store grouping information including a device ID (e.g., “DA1”) of the IoT device 320 and companion device information (e.g., [EFGH, TEMP]).

In operation 1520, the electronic device 310 may report the grouping information to the server 350.

In operation 1522, the electronic device 310 may determine whether an error situation of the IoT device 320 has occurred, based on sensor data collected via the companion devices (e.g., the sensor 2 330b and the sensor 3 330c). In an embodiment of the disclosure, the electronic device 310 may receive sensor data from the sensor 2 330b and the sensor 3 330c periodically or in response to a request, and analyze the sensor data to determine whether an error situation of the IoT device 320 has occurred or whether an early warning has been generated. In an embodiment of the disclosure, the electronic device 310 may report the sensor data or a corresponding analysis result to the server 350. In an embodiment of the disclosure, the electronic device 310 may provide (e.g., display or audibly output), to a user, a report and an action guide based on the sensor data or the corresponding analysis result.

In an embodiment of the disclosure, an IoT device (e.g., the IoT device 320) grouped with one or more external sensor devices may be managed based on one identifier (ID) (e.g., a device ID or a group ID of the IoT device 320). In an embodiment of the disclosure, the electronic device 310 may use the group ID during execution of an IoT client application to collectively manage functions, such as the states, operations, and automation of the IoT device 320 and the one or more external sensor devices.

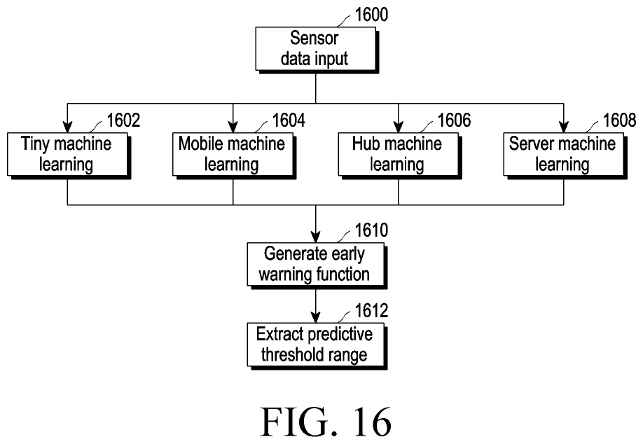

FIG. 16 illustrates a procedure for extracting a threshold range, based on sensor data according to an embodiment of the disclosure.

Referring to FIG. 16, sensor data 1600 may be collected by at least one external sensor device grouped with an IoT device (e.g., the IoT device 320). The sensor data 1600 may be input into any one of a tiny machine learning module 1602 included in the IoT device 320, a mobile machine learning module 1604 included in the electronic device 310, a hub machine learning module 1606 included in a hub (e.g., the IoT device 320a in FIG. 3), and/or a server machine learning module 1608 included in the server 350.

In an embodiment of the disclosure, the IoT device 320 may analyze the sensor data 1600 by using the tiny machine learning module 1602. In an embodiment of the disclosure, the electronic device 310 may analyze the sensor data 1600 by using the mobile machine learning module 1604. In an embodiment of the disclosure, the IoT device 320a may analyze the sensor data 1600 by using the hub machine learning module 1606. In an embodiment of the disclosure, the server 350 may analyze the sensor data 1600 by using the server machine learning module 1608.

In an embodiment of the disclosure, the electronic device 310 or the server 350 may generate an early warning function 1610 capable of detecting an early warning, based on information learned by at least one of the tiny machine learning module 1602, the mobile machine learning module 1604, the hub machine learning module 1606, or the server machine learning module 1608. The early warning function 1610 may calculate a threshold range for generating an early warning to the sensor data 1600. In an embodiment of the disclosure, the electronic device 310 or the server 350 may extract, based on the early warning function 1610, a predictive threshold range 1612 for use in generating an early warning.

In an embodiment of the disclosure, the server 350 may build a database with various types of data, such as device data collected from an external sensor device related to the IoT device 320, as well as other sensor devices of the same or similar model, external information, such as weather, data accumulated by developers, and user actions, and utilize the database to increase the accuracy of the determination of an early warning. In an embodiment of the disclosure, in addition to machine learning, artificial intelligence (AI)-based anomality detection techniques may be used to generate an early warning.

In an embodiment of the disclosure, the IoT device 320 may input sensor data received from the external sensor device into the tiny machine learning module 1602, thereby causing the tiny machine learning module 1602 to be trained based on the sensor data. In an embodiment of the disclosure, the IoT device 320 may generate an early warning function (e.g., the early warning function 1610) for error information, based on the information learned by the tiny machine learning module 1602. In an embodiment of the disclosure, the IoT device 320 may extract a predictive threshold range for the early warning function 1610 and detect an error situation, based on the predictive threshold range.

In an embodiment of the disclosure, the IoT device 320, the electronic device 310, the IoT device 320a, or the server 350 may continuously update the predictive threshold range 1612 by repeatedly performing the operation of generating the early warning function 1610 and extracting the predictive threshold range 1612. In an embodiment of the disclosure, based on sensor data values collected by the grouped external sensor devices exceeding the predictive threshold range 1612, the IoT device 320, the electronic device 310, the IoT device 320a, or the server 350 may generate an early warning related to the IoT device 320, or may determine that an error situation has occurred.

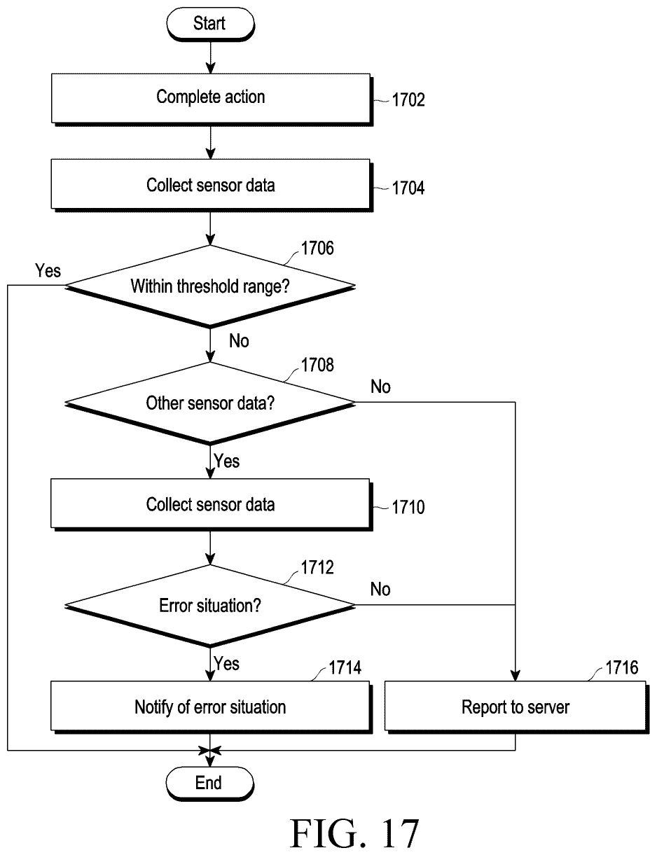

FIG. 17 is a flowchart illustrating a procedure for detecting an error situation according to an embodiment of the disclosure.

According to embodiments of the disclosure, at least one of operations described below may be omitted, modified, or executed in a different order. In an embodiment of the disclosure, at least one of the operations described below may be executed by a processor (e.g., the processor 220 in FIG. 2) of an electronic device 310. In an embodiment of the disclosure, memory (e.g., the memory 230 in FIG. 2) of the electronic device 310 may store instructions that cause the electronic device 310 to operate according to at least one of the operations described below.

Referring to FIG. 17, in operation 1702, the electronic device 310 (e.g., the processor 220) may identify that an action of the IoT device 320 is completed. In an embodiment of the disclosure, when the IoT device 320 is a washing machine, the action may include a washing operation. In operation 1704, the electronic device 310 (e.g., the processor 220) may collect, based on identifying that the action is completed, sensor data (e.g., first sensor data) from at least one external sensor device grouped with an IoT device 320. In an embodiment of the disclosure, the at least one external sensor device may include a vibration sensor and/or a water leak sensor.

In operation 1706, the electronic device 310 (e.g., the processor 220) may determine whether a value of the first sensor data collected from the at least one external sensor device falls within a designated threshold range (e.g., the predictive threshold range 1612 in FIG. 16). When the value of the first sensor data is within the threshold range, the electronic device 310 (e.g., the processor 220) may terminate the procedure. When the value of the first sensor data is not within the threshold range, the electronic device 310 (e.g., the processor 220) may proceed to operation 1708.

In operation 1708, the electronic device 310 (e.g., the processor 220) may determine whether there is other sensor data (e.g., sensor data collected by an external sensor device connected to a hub) related to the IoT device 320 other than the at least one external sensor device. When there is no other sensor data, the electronic device 310 (e.g., the processor 220) may proceed to operation 1716. When there is other sensor data, the electronic device 310 (e.g., the processor 220) may proceed to operation 1710.

In operation 1710, the electronic device 310 (e.g., the processor 220) may collect sensor data (e.g., second sensor data) via an external sensor device connected to a hub (e.g., the IoT device 320a in FIG. 3).

In operation 1712, the electronic device 310 (e.g., the processor 220) may determine, based on the first sensor data and the second sensor data, whether an error situation related to the IoT device 320 has been detected. In an embodiment of the disclosure, the electronic device 310 (e.g., the processor 220) may analyze the first sensor data and the second sensor data directly, or may analyze the first sensor data and the second sensor data via an external electronic device (e.g., the hub, the server 350, or another edge computing device). As a result of the analysis, when an error situation has not been detected, the electronic device 310 (e.g., the processor 220) may proceed to operation 1716. As a result of the analysis, when an error situation has been detected, the electronic device 310 (e.g., the processor 220) may proceed to operation 1714.

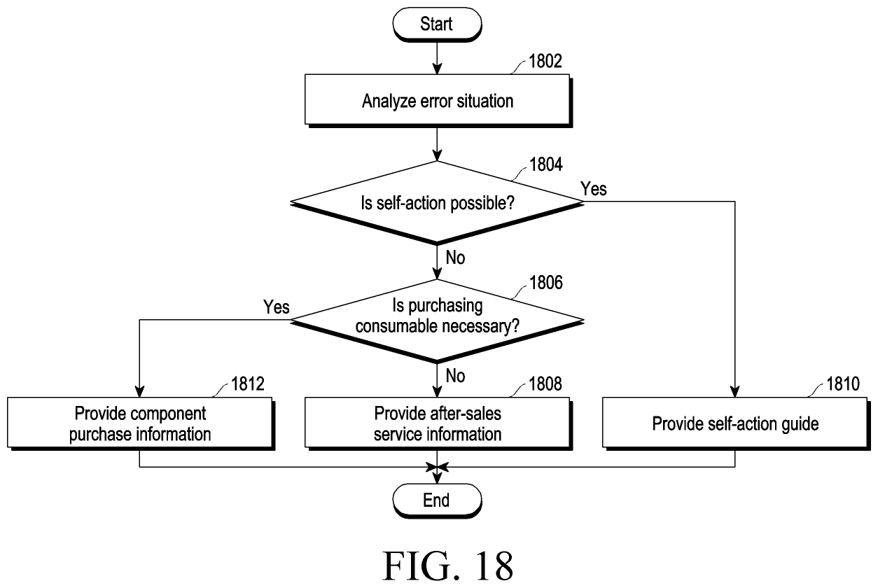

In operation 1714, the electronic device 310 (e.g., the processor 220) may provide (e.g., display, or audibly output), to a user, a notification message indicating that an error situation has occurred. In an embodiment of the disclosure, the electronic device 310 (e.g., the processor 220) may transmit the notification message to an after-sales service center 602, an IoT management center 604, and/or a manufacturer 606. In an embodiment of the disclosure, operation 1714 may correspond to the procedure in FIG. 18.

In operation 1716, the electronic device 310 (e.g., the processor 220) may transmit, to the server 350, a reporting message that includes a situation (e.g., a normal situation) detected based on the collected sensor data and/or the collected sensor data.

FIG. 18 is a flowchart illustrating a procedure for analyzing an error situation according to an embodiment of the disclosure.

According to embodiments of the disclosure, at least one of operations described below may be omitted, modified, or executed in a different order. In an embodiment of the disclosure, at least one of the operations described below may be executed by a processor (e.g., the processor 220 in FIG. 2) of an electronic device 310. In an embodiment of the disclosure, memory (e.g., the memory 230 in FIG. 2) of the electronic device 310 may store instructions that cause the electronic device 310 to operate according to at least one of the operations described below.

Referring to FIG. 18, in operation 1802, the electronic device 310 (e.g., the processor 220) may analyze an error situation detected for an IoT device 320 (e.g., the error situation detected in operation 1712 in FIG. 17). In an embodiment of the disclosure, the electronic device 310 (e.g., the processor 220) may retrieve an action guide corresponding to the error situation from a database that stores action guides corresponding to error situations.

In operation 1804, the electronic device 310 (e.g., the processor 220) may determine whether the error situation can be resolved by a user's self-action. When the error situation can be resolved by the user's self-action, the electronic device 310 (e.g., the processor 220) may proceed to operation 1810 to provide (e.g., display or audibly output) a self-action guide to the user. When the error situation can be resolved by the user's self-action, the electronic device 310 (e.g., the processor 220) may proceed to operation 1806.

In operation 1806, the electronic device 310 (e.g., the processor 220) may determine whether purchasing a consumable for the IoT device 320 is necessary to resolve the error situation. When purchasing a consumable is necessary, the electronic device 310 (e.g., the processor 220) may proceed to operation 1812 to provide (e.g., display) consumable purchase information (e.g., the website address or phone number of a consumable store) to the user. When purchasing a consumable is not necessary, the electronic device 310 (e.g., the processor 220) may proceed to operation 1808.

In operation 1808, the electronic device 310 (e.g., the processor 220) may provide (e.g., display) after-sales service information (e.g., the website address or phone number of an after-sales service center) to the user.

In an embodiment of the disclosure, the IoT device 320 may be a washing machine, and external sensor devices (e.g., a water leak sensor and a vibration sensor) may be located in the vicinity of the washing machine (e.g., in the same room). Here, the water leak sensor may be installed in the drain of the washing machine, and the vibration sensor may be attached to the exterior of the washing machine. In an embodiment of the disclosure, the washing machine may be configured to provide only a power on/off function via an IoT service and may not have any internal sensors.

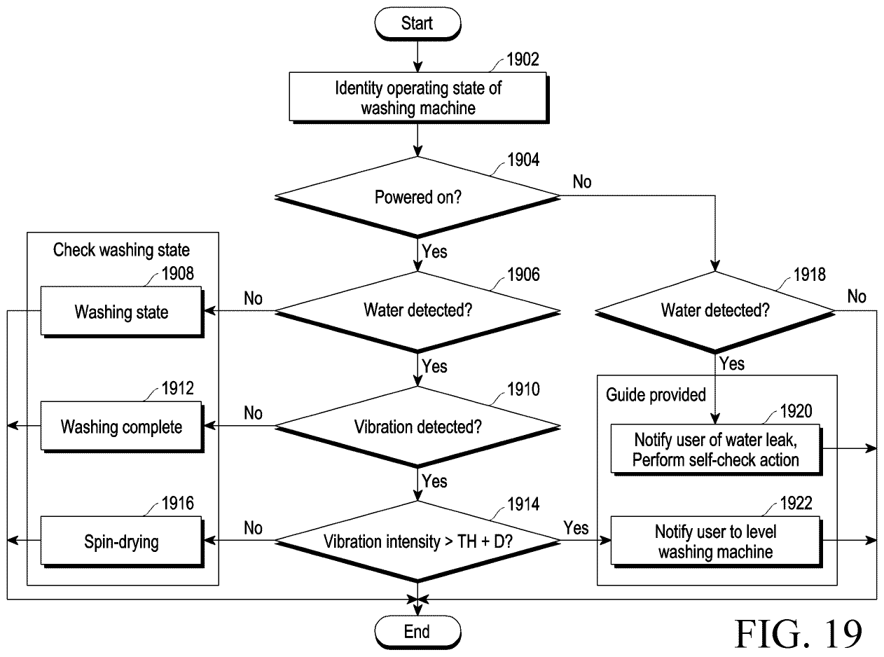

In an embodiment of the disclosure, the electronic device 310 may group the washing machine with the water leak sensor and the vibration sensor via the above-described procedure (e.g., the procedure in FIG. 12, 13, or 15). In an embodiment of the disclosure, the electronic device 310 may determine an operation situation of the washing machine via the grouped water leak sensor and vibration sensor, as shown in the procedure in FIG. 19.

FIG. 19 is a flowchart illustrating error situation detection based on sensor data collected from a grouped sensor according to an embodiment of the disclosure.

According to embodiments of the disclosure, at least one of operations described below may be omitted, modified, or executed in a different order. In an embodiment of the disclosure, at least one of the operations described below may be executed by a processor (e.g., the processor 220 in FIG. 2) of an electronic device 310. In an embodiment of the disclosure, memory (e.g., the memory 230 in FIG. 2) of the electronic device 310 may store instructions that cause the electronic device 310 to operate according to at least one of the operations described below.

Referring to FIG. 19, in operation 1902, the electronic device 310 may receive, from a washing machine, information indicating an operating state of the washing machine, and may receive sensor data from each of a water leak sensor and a vibration sensor. In an embodiment of the disclosure, the sensor data from the water leak sensor may indicate that water flow is detected or that water flow is not detected. In an embodiment of the disclosure, the sensor data from the vibration sensor may indicate a vibration intensity. In an embodiment of the disclosure, the operating state may indicate power-on or power-off.

In operation 1904, the electronic device 310 may determine whether the washing machine is powered on, based on the information indicating the operating state. When the washing machine is powered on, the electronic device 310 may proceed to operation 1906. When the washing machine is not powered on, the electronic device 310 may proceed to operation 1918.

In operation 1906, the electronic device 310 may determine whether water has been detected by the water leak sensor. When water is not detected by the water leak sensor, the electronic device 310 may proceed to operation 1908. When water is detected by the water leak sensor, the electronic device 310 may proceed to operation 1910.

In operation 1910, the electronic device 310 may determine whether a vibration has been detected by the vibration sensor. When the vibration is not detected by the vibration sensor, the electronic device 310 may proceed to operation 1912. When the vibration is detected by the vibration sensor, the electronic device 310 may proceed to operation 1914.

In operation 1914, the electronic device 310 may determine whether the vibration intensity detected by the vibration sensor is greater than a designated threshold (e.g., average intensity) by at least a predetermined value. When the vibration intensity is not greater than a threshold TH (e.g., average vibration intensity) by at least a predetermined value D, the electronic device 310 may proceed to operation 1916. When the vibration intensity is greater than the threshold by the at least predetermined value, the electronic device 310 may proceed to operation 1922.

In operation 1918, the electronic device 310 may determine whether water has been detected by the water leak sensor. When water is not detected by the water leak sensor, the electronic device 310 may terminate the procedure. When water is detected by the water leak sensor, the electronic device 310 may proceed to operation 1920.

In an embodiment of the disclosure, when the washing machine is powered on and the water leak sensor has not detected water, the electronics 310 may determine, in operation 1908, that the washing machine is in a “washing state” in which the washing machine is spinning a drum to wash laundry.

In an embodiment of the disclosure, when the washing machine is powered on, the water leak sensor has detected water, and the vibration intensity detected by the vibration sensor is less than a designated threshold, the electronic device 310 may determine, in operation 1912, that the washing machine is discharging water after “the completion of washing.”

In an embodiment of the disclosure, when the washing machine is powered on, the leak sensor has detected water, and the vibration intensity detected by the vibration sensor is greater than the designated threshold (e.g., 0), the electronic device 310 may determine, in operation 1916, that the washing machine is in “a spin-dry state.”

In an embodiment of the disclosure, when the washing machine is powered on and the vibration intensity detected by the vibration sensor is greater than the designated threshold (e.g., average value) by at least a predetermined value, the electronic device 310 may determine, in operation 1922, that the washing machine is in an unbalanced error situation. Based on the detection of the error situation, the electronic device 310 may provide (e.g., display or audibly output), to the user, a notification message instructing the user to re-level the washing machine, thereby preventing malfunction of the washing machine.

In an embodiment of the disclosure, when the washing machine is powered on but the vibration intensity detected by the vibration sensor is less than the designated threshold for a designated period of time, the electronic device 310 may determine “washing complete” in operation 1912. When determining “washing complete,” the electronic device 310 may transmit a command to turn off power to the washing machine, thereby saving energy.

In an embodiment of the disclosure, when the washing machine is powered off and the water leak sensor detects water, the electronic device 310 may determine that a water supply hose is improperly secured or disconnected, thereby potentially causing a leak. In operation 1920, the electronic device 310 may provide (e.g., display or audibly output) a notification message indicating the risk of a leak to the user, thereby prompting the user to check the water supply hose.

In the embodiments of the disclosure, by grouping a washing machine, which does not include internal sensors, with external sensor devices (e.g., a vibration sensor and/or a water leak sensor), it is possible to determine the operating state of the washing machine, such as washing, draining, spin-drying, or washing complete, thereby enabling a user to enjoy an improved customer experience without the need to purchase new home appliances.

FIGS. 20A, 20B, and 20C illustrate user interfaces showing a grouped sensor according to various embodiments of the disclosure.

Referring to FIG. 20A, an electronic device 310 may display a user interface 2010 based on completing sensor grouping. In an embodiment of the disclosure, the user interface 2010 may include a first object corresponding to an IoT device 320 (e.g., a washing machine), at least one second object corresponding to at least one external sensor device (e.g., a vibration sensor), and a connection line connecting the at least one second object to the first object.

Referring to FIG. 20B, an electronic device 310 may display a user interface 2020 based on completing sensor grouping. In an embodiment of the disclosure, the user interface 2020 may include a first object corresponding to an IoT device 320 (e.g., a washing machine), and a second object (e.g., “Connected: 5”) indicating the presence of one or more (e.g., five) external sensor devices connected to the IoT device 320.

Referring to FIG. 20C, an electronic device 310 may display a user interface 2030 based on completing sensor grouping. In an embodiment of the disclosure, the user interface 2030 may list a first object corresponding to an IoT device 320 (e.g., a washing machine), and at least one second object corresponding to at least one external sensor device connected to the IoT device 320.

An electronic device 310, according to an embodiment of the disclosure, may include communication circuitry 292, at least one processor 220, and memory 230 configured to store instructions. The instructions, when executed by the at least one processor individually or collectively, may cause the electronic device to receive a first user input requesting sensor grouping of an Internet of Things (IoT) device 320. The instructions, when executed by the at least one processor individually or collectively, may cause the electronic device to display, based on the first user input, a guide message requesting movement to the IoT device. The instructions, when executed by the at least one processor individually or collectively, may cause the electronic device to discover, after displaying the guide message, the IoT device by using a short-range communication method via the communication circuitry. The instructions, when executed by the at least one processor, individually or collectively, may cause the electronic device to discover, after discovering the IoT device, one or more external sensor devices by using the short-range communication method via the communication circuitry. The instructions, when executed by the at least one processor individually or collectively, may cause the electronic device to receive sensor device information and signal strength information from the one or more external sensor devices via the communication circuitry. The instructions, when executed by the at least one processor individually or collectively, may cause the electronic device to group, based on the sensor device information and the signal strength information, at least one sensor device among the one or more external sensor devices with the IoT device. The instructions, when executed by the at least one processor individually or collectively, may cause the electronic device to determine an operating situation of the IoT device, based on sensor data received from the at least one grouped external sensor device via the communication circuitry.

In an embodiment of the disclosure, the instructions, when executed by the at least one processor individually or collectively, may cause the electronic device to detect an error situation of the IoT device based on the sensor data, and to provide, based on the error situation being detected, action guidance information related to the error situation.

In an embodiment of the disclosure, the instructions, when executed by the at least one processor individually or collectively, may cause the electronic device to establish a device-to-device (D2D) connection with the IoT device based on discovering the IoT device, transmit a request message to the IoT device via the D2D connection, and receive device information including a device identifier (ID) of the IoT device from the IoT device via the D2D connection after transmitting the request message.

In an embodiment of the disclosure, the instructions, when executed by the at least one processor individually or collectively, may cause the electronic device to receive, after discovering the IoT device, a second user input requesting a surrounding sensor search, and to perform, based on the second user input, a scan to discover the one or more external sensor devices.

In an embodiment of the disclosure, the instructions, when executed by the at least one processor individually or collectively, may cause the electronic device to determine, based on the signal strength information, that an external sensor device, having a signal strength higher than a designated threshold, among the one or more external sensor devices is to be grouped with the IoT device.

In an embodiment of the disclosure, the instructions, when executed by the at least one processor individually or collectively, may cause the electronic device to exclude, from the grouping, based on the sensor device information, an external sensor device having a sensor type that is not required for detecting an operating situation of the IoT device among the one or more external sensor devices. In an embodiment of the disclosure, the instructions, when executed by the at least one processor individually or collectively, may cause the electronic device to, based on the sensor device information, exclude, from the grouping, an external sensor device having a sensor type of a sensor embedded in the IoT device.

In an embodiment of the disclosure, the instructions, when executed by the at least one processor individually or collectively, may cause the electronic device to display a user interface including objects corresponding to one or more first external sensor devices, receive a second user input for selecting at least one of the objects via the user interface, and, based on the second user input, group the at least one first external sensor device corresponding to the at least one selected object with the IoT device.

In an embodiment of the disclosure, the instructions, when executed by the at least one processor individually or collectively, may cause the electronic device to transmit, based on the first user input, a request message to a server 350 for a sensor list related to the IoT device, receive a sensor list indicating at least one second external sensor device from the server after transmitting the request message, and group the at least one second external sensor device with the IoT device.

An Internet of things (IoT) device 320, according to an embodiment of the disclosure, may include communication circuitry 414, at least one processor 412, and memory 416 configured to store instructions. The instructions, when executed by the at least one processor individually or collectively, may cause the IoT device to receive a command requesting a surrounding sensor search from an electronic device 310 through the communication circuitry. The instructions, when executed by the at least one processor individually or collectively, may cause the IoT device to discover, based on receiving the command, one or more external sensor devices by using a short-range communication method through the communication circuitry. The instructions, when executed by the at least one processor individually or collectively, may cause the IoT device to receive sensor device information and signal strength information from the one or more external sensor devices through the communication circuitry. The instructions, when executed by the at least one processor individually or collectively, may cause the IoT device to group, based on the sensor device information and the signal strength information, at least one external sensor device among the one or more external sensor devices with the IoT device. The instructions, when executed by the at least one processor individually or collectively, may cause the IoT device to receive sensor data from the at least one external sensor device through the communication circuitry. The instructions, when executed by the at least one processor individually or collectively, may cause the IoT device to transmit the sensor data to the electronic device 310 through the communication circuitry.

In an embodiment of the disclosure, the instructions, when executed by the at least one processor individually or collectively, may cause the IoT device to determine, based on the signal strength information, that an external sensor device, having a signal strength higher than a designated threshold, among the one or more external sensor devices is to be grouped with the IoT device. In an embodiment of the disclosure, the instructions, when executed by the at least one processor individually or collectively, may cause the IoT device to, based on the sensor device information, exclude, from the grouping, at least one external sensor device having a sensor type that is not required for detecting an operating situation of the IoT device among the one or more external sensor devices. In an embodiment of the disclosure, the instructions, when executed by the at least one processor individually or collectively, may cause the IoT device to, based on the sensor device information, exclude, from grouping, at least one external sensor device having a sensor type of a sensor embedded in the IoT device.

A method performed by an electronic device 310, according to an embodiment of the disclosure, may include: an operation 902 of receiving a first user input requesting sensor grouping of an Internet of Things (IoT) device 320, an operation 904 of displaying, based on the first user input, a guide message requesting movement to the IoT device, an operation 906 of discovering, after displaying the guide message, the IoT device by using a short-range communication method, an operation 910 of discovering, after discovering the IoT device, one or more external sensor devices by using the short-range communication method, an operation 912 of receiving sensor device information and signal strength information from the one or more external sensor devices, an operation 914 of grouping, based on the sensor device information and the signal strength information, at least one external sensor device among the one or more external sensor devices with the IoT device, and an operation 916 of determining an operating situation of the IoT device, based on sensor data received from the at least one grouped external sensor device.

In an embodiment of the disclosure, the method may include an operation of detecting an error situation of the IoT device, based on the sensor data, and an operation of providing action guide information related to the error situation, based on the error situation being detected.

In an embodiment of the disclosure, the method may include an operation of establishing, based on discovering the IoT device, a device-to-device (D2D) connection with the IoT device, an operation of transmitting a request message to the IoT device via the D2D connection, and an operation of receiving device information including a device identifier (ID) of the IoT device from the IoT device via the D2D connection after transmitting the request message.

In an embodiment of the disclosure, the method may include an operation of receiving, after discovering the IoT device, a second user input requesting a surrounding sensor search, and an operation of performing, based on the second user input, a scan to discover the one or more external sensor devices.

In an embodiment of the disclosure, the method may include an operation of determining, based on the signal strength information, that an external sensor device, having a signal strength higher than a designated threshold, among the one or more external sensor devices is to be grouped with the IoT device.

In an embodiment of the disclosure, the method may include an operation of, based on the sensor device information, excluding, from the grouping, an external sensor device having a sensor type that is not required for detecting an operating situation of the IoT device among the one or more external sensor devices. In an embodiment of the disclosure, the method may include an operation of, based on the sensor device information, excluding, from the grouping, an external sensor device having a sensor type of a sensor embedded in the IoT device.

In an embodiment of the disclosure, the method may include an operation of displaying a user interface including objects corresponding to one or more first external sensor devices, an operation of receiving a second user input selecting at least one object from among the objects via the user interface, and an operation of grouping, based on the second user input, at least one first external sensor device corresponding to the at least one selected object with the IoT device.

In an embodiment of the disclosure, the method may include an operation of transmitting, based on the first user input, a request message to a server 350 for a sensor list related to the IoT device, an operation of receiving a sensor list indicating at least one second external sensor device from the server after transmitting the request message, and an operation of grouping the at least one second external sensor device with the IoT device.

A method performed by an Internet of things (IoT) device 320, according to an embodiment of the disclosure, may include an operation 802 of receiving, from an electronic device 310, a command requesting a surrounding sensor search, an operation 804 of discovering, based on receiving the command, one or more external sensor devices by using a short-range communication method, an operation 806 of receiving sensor device information and signal strength information from the one or more external sensor devices, an operation 808 of grouping at least one external sensor device among the one or more external sensor devices with the IoT device, based on the sensor device information and the signal strength information, and an operation of transmitting sensor data, received from the at least one external sensor device, to the electronic device.

In an embodiment of the disclosure, the method may include an operation of determining, based on the signal strength information, that an external sensor device, having a signal strength higher than a designated threshold, among the one or more external sensor devices is to be grouped with the IoT device. In an embodiment of the disclosure, the method may include an operation of, based on the sensor device information, excluding, from the grouping, at least one external sensor device having a sensor type that is not required for detecting an operating situation of the IoT device among the one or more external sensor devices. In an embodiment of the disclosure, the method may include an operation of, based on the sensor device information, excluding, from the grouping, at least one external sensor device having a sensor type of a sensor embedded in the IoT device.

In accordance with another aspect of the disclosure, in one or more non-transitory computer-readable storage media storing one or more computer programs including computer-executable instructions that, when executed by at least one processor of an electronic device individually or collectively, cause the electronic device to perform operations are provided. The operations include receiving a first user input requesting sensor grouping of an Internet of things (IoT) device, based on the first user input, displaying a guide message requesting movement to the IoT device, after displaying the guide message, discovering the IoT device by using a short-range communication method, after discovering the IoT device, discovering one or more external sensor devices by using the short-range communication method, receiving sensor device information and signal strength information from the one or more external sensor devices through a communication circuitry, based on the sensor device information and the signal strength information, grouping at least one external sensor device among the one or more external sensor devices with the IoT device, and based on sensor data received from the at least one grouped external sensor device, determining an operating situation of the IoT device.

In accordance with another aspect of the disclosure, in one or more non-transitory computer-readable storage media storing one or more computer programs including instructions that, when executed by at least one processor of an IoT device individually or collectively, cause the IoT device to perform operations are provided. The operations include receiving, from an electronic device, a command requesting a surrounding sensor search, based on receiving the command, discovering one or more external sensor devices by using a short-range communication method through communication circuitry, receiving sensor device information and signal strength information from the one or more external sensor devices through the communication circuitry, based on the sensor device information and the signal strength information, grouping at least one external sensor device among the one or more external sensor devices with the IoT device, receiving sensor data received from the at least one grouped external sensor device through the communication circuitry, and transmitting the sensor data to the electronic device through the communication circuitry.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
memory, comprising one or more storage media, storing instructions; and
at least one processor communicatively coupled to the communication circuitry and the memory,
wherein the instructions, when executed by the at least one processor individually or collectively, cause the electronic device to:
receive a first user input for requesting sensor grouping of an Internet of things (IoT) device,
based on the first user input, display a guide message requesting movement to the IoT device,
after displaying the guide message, discover the IoT device by using a short-range communication method through the communication circuitry,
after discovering the IoT device, discover one or more external sensor devices by using the short-range communication method through the communication circuitry,
receive sensor device information and signal strength information from the one or more external sensor devices through the communication circuitry,
based on the sensor device information and the signal strength information, group at least one external sensor device among the one or more external sensor devices with the IoT device, and
based on sensor data received from the at least one grouped external sensor device through the communication circuitry, determine an operating situation of the IoT device.

2. The electronic device of claim 1, wherein the instructions, when executed by the at least one processor individually or collectively, further cause the electronic device to:
detect an error situation of the IoT device based on the sensor data; and
based on the error situation being detected, provide action guide information related to the error situation.

3. The electronic device of claim 1, wherein the instructions, when executed by the at least one processor individually or collectively, further cause the electronic device to:
based on discovering the IoT device, establish a device-to-device (D2D) connection with the IoT device,
transmit a request message to the IoT device through the D2D connection, and
after transmitting the request message, receive device information including a device identifier (ID) of the IoT device from the IoT device via the D2D connection.

4. The electronic device of claim 1, wherein the instructions, when executed by the at least one processor individually or collectively, further cause the electronic device to:
after discovering the IoT device, receive a second user input for requesting a surrounding sensor search, and
based on the second user input, perform a scanning to discover the one or more external sensor devices.

5. The electronic device of claim 1, wherein the instructions, when executed by the at least one processor individually or collectively, further cause the electronic device to:
based on the signal strength information, determine that an external sensor device among the one or more external sensor devices having a signal strength higher than a designated threshold is to be grouped with the IoT device.

6. The electronic device of claim 1, wherein the instructions, when executed by the at least one processor individually or collectively, further cause the electronic device to:
based on the sensor device information, exclude from the grouping an external sensor device having a sensor type that is not required for detecting an operating situation of the IoT device among the one or more external sensor devices, and/or
based on the sensor device information, exclude from the grouping an external sensor device having a sensor type of a sensor mounted into the IoT device.

7. The electronic device of claim 1, wherein the instructions, when executed by the at least one processor individually or collectively, further cause the electronic device to:
display a user interface including objects corresponding to one or more first external sensor devices,
receive a second user input for selecting at least one of the objects through the user interface, and
based on the second user input, group at least one first external sensor device corresponding to the at least one selected object with the IoT device.

8. The electronic device of claim 1, wherein the instructions, when executed by the at least one processor individually or collectively, further cause the electronic device to:
based on the first user input, transmit a request message to a server for a sensor list related to the IoT device,
after transmitting the request message, receive a sensor list indicating at least one second external sensor device from the server, and
group the at least one second external sensor device with the IoT device.

9. An Internet of things (IoT) device comprising:
communication circuitry;
memory, comprising one or more storage media, storing instructions; and
at least one processor communicatively coupled to the communication circuitry and the memory; and
wherein the instructions, when executed by the at least one processor individually or collectively, cause the IoT device to:
receive a command requesting a surrounding sensor search from an electronic device through the communication circuitry,
based on receiving the command, discover one or more external sensor devices by using a short-range communication method through the communication circuitry,
receive sensor device information and signal strength information from the one or more external sensor devices through the communication circuitry,
based on the sensor device information and the signal strength information, group at least one external sensor device among the one or more external sensor devices with the IoT device,
receive sensor data from the at least one external sensor device through the communication circuitry, and
transmit the sensor data to the electronic device through the communication circuitry.

10. The IoT device of claim 9, wherein the instructions, when executed by the at least one processor individually or collectively, further cause the IoT device to:
based on the signal strength information, determine that an external sensor device, having a signal strength higher than a designated threshold, among the one or more external sensor devices is to be grouped with the IoT device,
based on the sensor device information, exclude, from the grouping, at least one external sensor device having a sensor type that is not required for detecting an operating situation of the IoT device among the one or more external sensor devices, and/or
based on the sensor device information, exclude, from grouping, at least one external sensor device having a sensor type of a sensor embedded in the IoT device.

11. A method performed by an electronic device, the method comprising:
receiving a first user input requesting sensor grouping of an Internet of things (IoT) device;
based on the first user input, displaying a guide message requesting movement to the IoT device;
after displaying the guide message, discovering the IoT device by using a short-range communication method;
after discovering the IoT device, discovering one or more external sensor devices by using the short-range communication method;
receiving sensor device information and signal strength information from the one or more external sensor devices through a communication circuitry;
based on the sensor device information and the signal strength information, grouping at least one external sensor device among the one or more external sensor devices with the IoT device; and
based on sensor data received from the at least one grouped external sensor device, determining an operating situation of the IoT device.

12. The method of claim 11, further comprising:
detecting an error situation of the IoT device, based on the sensor data; and
based on the error situation being detected, providing action guide information related to the error situation.

13. The method of claim 11, further comprising:
based on discovering the IoT device, establishing a device-to-device (D2D) connection with the IoT device;
transmitting a request message to the IoT device via the D2D connection; and
after transmitting the request message, receiving device information comprising a device identifier (ID) of the IoT device from the IoT device via the D2D connection.

14. The method of claim 11, further comprising:
after discovering the IoT device, receiving a second user input requesting a surrounding sensor search; and
based on the second user input, performing a scan to discover the one or more external sensor devices.

15. The method of claim 11, further comprising
based on the signal strength information, determining that an external sensor device, having a signal strength higher than a designated threshold, among the one or more external sensor devices is to be grouped with the IoT device.

16. The method of claim 11, further comprising:
based on the sensor device information, excluding, from the grouping, an external sensor device having a sensor type that is not required for detecting an operating situation of the IoT device among the one or more external sensor devices; and/or
based on the sensor device information, excluding, from the grouping, an external sensor device having a sensor type of a sensor embedded in the IoT device.

17. The method of claim 11, further comprising:
displaying a user interface comprising objects corresponding to one or more first external sensor devices;
receiving a second user input selecting at least one object from among the objects through the user interface; and
based on the second user input, grouping at least one first external sensor device corresponding to the at least one selected object with the IoT device.

18. The method of claim 11, further comprising:
based on the first user input, transmitting a request message to a server for a sensor list related to the IoT device;
after transmitting the request message, receiving a sensor list indicating at least one second external sensor device from the server; and
grouping the at least one second external sensor device with the IoT device.

19. A method performed by an Internet of things (IoT) device, the method comprising:
receiving, from an electronic device, a command requesting a surrounding sensor search;
based on receiving the command, discovering one or more external sensor devices by using a short-range communication method;
receiving sensor device information and signal strength information from the one or more external sensor devices through a communication circuitry;
based on the sensor device information and the signal strength information, grouping at least one external sensor device among the one or more external sensor devices with the IoT device; and
transmitting sensor data, received from the at least one external sensor device, to the electronic device.

20. The method of claim 19, comprising:
based on the signal strength information, determining that an external sensor device, having a signal strength higher than a designated threshold, among the one or more external sensor devices is to be grouped with the IoT device;
based on the sensor device information, excluding, from the grouping, at least one external sensor device having a sensor type that is not required for detecting an operating situation of the IoT device among the one or more external sensor devices; and/or
based on the sensor device information, excluding, from the grouping, at least one external sensor device having a sensor type of a sensor embedded in the IoT device.
